(19) United States
(12) Patent Application Publication
(10) Pub. No.: US 2025/0327502 A1
(43) Pub. Date: Oct. 23, 2025

(54) PISTON ASSEMBLY AND MAGNETORHEOLOGICAL DAMPER, VEHICLE

(71) Applicant: T-MAX (HANGZHOU) TECHNOLOGY CO., LTD., Hangzhou (CN)

(72) Inventors: Xinfa DU, Hangzhou (CN); Yongyong ZHAN, Hangzhou (CN); Ke WANG, Hangzhou (CN); Songfeng WANG, Hangzhou (CN); Lei YANG, Hangzhou (CN)

(21) Appl. No.: 18/823,538

(22) Filed: Sep. 3, 2024

(30) Foreign Application Priority Data
Apr. 17, 2024 (CN) 202410465649.4
Apr. 17, 2024 (CN) 202420808747.9

(51) Int. Cl. F16F 9/32; F16F 9/53

(52) U.S. Cl. CPC F16F 9/3214; F16F 9/535

(57) ABSTRACT

Disclosed is a piston assembly for a magnetorheological damper, which the piston assembly includes a piston rod and a piston, and the piston includes a shell, a first-end iron core, a second-end iron core, a main iron core, a coil bracket, an electromagnetic coil, a first supporting frame, and a second supporting frame. In some embodiments, the shell is provided with a first magnetorheological fluid inlet/outlet and a second magnetorheological fluid inlet/outlet, and the first-end iron core and the second-end iron core are arranged inside the shell; In some embodiments, the main iron core has a central through-hole, and the main iron core is arranged inside the shell and located between the first-end iron core and the second-end iron core; and/or, in some embodiments, the first supporting frame and the second supporting frame are arranged inside the shell.

### CROSS-REFERENCE TO RELATED APPLICATIONS

This patent document claims priority to and benefits of Chinese Patent Application Serial No. 202410465649.4, filed on Apr. 17, 2024, and Chinese Patent Application Serial No. 202420808747.9, filed on Apr. 17, 2024. The entire content of the aforementioned patent document is incorporated by reference for all purposes.

### TECHNICAL FIELD

The present technology relates to the field of damper pistons, and particularly to a piston assembly of a magnetorheological damper, a magnetorheological damper, and a vehicle provided with the magnetorheological damper.

### BACKGROUND

A magnetorheological damper (also referred to as a magnetorheological shock absorber) is a damper filled with magnetorheological fluid, which is controlled by a magnetic field, usually using an electromagnet. This allows the damping characteristics of the damper to be continuously controlled by varying the power of the electromagnet.

### SUMMARY

Embodiments of the present technology include a magnetorheological damper with an increased damping force and a small volume.

In some aspects, a piston assembly of a magnetorheological damper according to some embodiments of the present technology includes: a piston rod, in which the piston rod has a first end and a second end; and a piston connected to the first end of the piston rod, in which the piston includes: a shell provided with a first magnetorheological fluid inlet/outlet and a second magnetorheological fluid inlet/outlet, a first-end iron core arranged inside the shell, in which there is a first gap between an outer peripheral surface of the first-end iron core and an inner peripheral surface of the shell, and the first gap is in connection with the first magnetorheological fluid inlet/outlet to form a first axial flow channel, a second-end iron core arranged inside the shell, in which there is a second gap between an outer peripheral surface of the second-end iron core and an inner peripheral surface of the shell, and the second gap is in connection with the second magnetorheological fluid inlet/outlet to form a second axial flow channel, a main iron core, in which the main iron core has a central through-hole, the main iron core is arranged inside the shell and located between the first-end iron core and the second-end iron core, and the main iron core is spaced from the first-end iron core and is spaced from the second-end iron core, a coil bracket arranged inside the shell and sleeved on the main iron core, an electromagnetic coil wound around an outer peripheral surface of the coil bracket, a first supporting frame arranged inside the shell, in which the first supporting frame includes a plurality of first legs sandwiched between the first-end iron core and the main iron core and arranged radially to form, between the first-end iron core and the main iron core, a plurality of first radial flow channels connected with the central through-hole, and the first radial flow channel is in connection with the first gap, and a second supporting frame arranged inside the shell, in which the second supporting frame includes a plurality of second legs sandwiched between the second-end iron core and the main iron core and arranged radially to form, between the second-end iron core and the main iron core, a plurality of second radial flow channels connected with the central through-hole, and the second radial flow channel is in connection with the second gap.

The piston assembly of the magnetorheological damper in accordance with example embodiments of the present technology effectively utilizes an internal space of the shell of the piston, and extends an effective length of the magnetorheological fluid channel by combining radial and axial flow channels. A requirement of increasing the damping force is achieved without extending an axial length of the piston, without increasing the number of electromagnetic coils, and without increasing a power consumption of an entire machine. It can also be said that under a condition of a same damping force, the axial length of the piston in accordance with example embodiments of the present technology can be greatly shortened, reducing a volume of the piston. In addition, the magnetorheological fluid channel is only provided inside the piston, which does not affect a structural strength of the piston rod. The piston assembly in accordance with example embodiments of the present technology has advantages of high structural strength, compact structure, and small volume.

In some embodiments, the shell includes: a sleeve for iron cores; a first piston cover, in which the first piston cover is arranged at a first end of the sleeve and connected to the piston rod, and the first magnetorheological fluid inlet/outlet is formed on the first piston cover and is aligned with the first gap in an axial direction of the sleeve; and a second piston cover, in which the second piston cover is arranged at a second end of the sleeve and connected to the piston rod, and the second magnetorheological fluid inlet/outlet is formed on the second piston cover and is aligned with the second gap in the axial direction of the sleeve.

In some embodiments, a plurality of the first magnetorheological fluid inlet/outlet are provided and spaced in a circumferential direction of the first piston cover; and/or a plurality of the second magnetorheological fluid inlet/outlet are provided and spaced in a circumferential direction of the second piston cover.

In some embodiments, the first magnetorheological fluid inlet/outlet is arc-shaped extending along a circumferential direction of the first piston cover, and/or the second magnetorheological fluid inlet/outlet is arc-shaped extending along a circumferential direction of the second piston cover.

In some embodiments, a first end of the shell is provided with a first connecting hole, and the first-end iron core is provided with a second connecting hole, in which the first connecting hole, the second connecting hole, and the central through-hole of the main iron core are aligned centrally in an axial direction of the main iron core, the first end of the piston rod is connected inside the first connecting hole and the second connecting hole, and a lead wire through-hole extending along an axial direction of the piston rod is provided inside the piston rod; and the electromagnetic coil includes a first lead wire and a second lead wire, and the first lead wire and the second lead wire extend from the central through-hole of the main iron core and extend outward through the lead wire through-hole.

In some embodiments, a filling layer for preventing the first lead wire and the second lead wire from moving is filled inside the lead wire through-hole.

In some embodiments, an annular groove is provided on an outer peripheral surface of the coil bracket, and the electromagnetic coil is arranged inside the circular groove, the electromagnetic coil includes a first lead wire and a second lead wire, the circular groove has a first side wall and a second side wall, the first side wall is provided with a first through slot, the first lead wire passes through the first through slot and extends outward, the second side wall is provided with a second through slot, and the second lead wire passes through the second through slot and extends outward.

In some embodiments, the first through slot is aligned with one first leg in the plurality of first legs, the first leg is provided with a first lead wire channel extending along a length direction of the first leg, and the first lead wire extends inward along a radial direction of the main iron core through the first lead wire channel and then extends outward along an axial direction of the main iron core, and the second through slot is aligned with one second leg in the plurality of second legs, the second leg is provided with a second lead wire channel extending along a length direction of the second leg, and the second lead wire extends inward along a radial direction of the main iron core through the second lead wire channel and then extends outward by passing through the central through-hole of the main iron core.

In some embodiments, the first supporting frame includes a first supporting tube, the plurality of first legs extend outward from the first supporting tube along a radial direction of the first supporting tube, a part of the first supporting tube is matched in the central through-hole of the main iron core, and a first guide slot extending along an axial direction of the first supporting tube is provided on the first supporting tube, and the second supporting frame includes a second supporting tube, the plurality of second legs extend outward from the second supporting tube along a radial direction of the second supporting tube, a part of the second supporting tube is matched in the central through-hole of the main iron core and contacts with the first supporting tube, a second guide slot extending along an axial direction of the second supporting tube is provided on the second supporting tube, and the first guide slot is aligned with the second guide slot to guide the second lead wire to pass through the central through-hole of the main iron core.

In some embodiments, the second guide slot is adjacent to and is in connection with the second lead wire channel.

In some embodiments, the first supporting frame includes a first supporting tube, a part of the first supporting tube is matched in the central through-hole of the main iron core, the plurality of first legs are spaced in a circumferential direction of the first supporting tube and connected to an outer peripheral surface of the first supporting tube, and the first supporting tube is provided with a first pass-through slot for connecting the first radial flow channel with the central through-hole; and/or the second supporting frame includes a second supporting tube, a part of the second supporting tube is matched in the central through-hole of the main iron core, the plurality of second legs are spaced in a circumferential direction of the second supporting tube and connected to an outer peripheral surface of the second supporting tube, and the second supporting tube is provided with a second pass-through slot for connecting the second radial flow channel with the central through-hole.

In some embodiments, the coil bracket has a first end face and a second end face opposite to the first end face in an axial direction of the coil bracket; the first leg is in contact with the first end face, and an outer end face of the first leg is flush with an outer circumferential edge of the first end face; and/or the second leg is in contact with the second end face, and an outer end face of the second leg is flush with an outer circumferential edge of the second end face.

In some embodiments, a plurality of first clamp slots are provided on the first end face, and the plurality of first legs are clamped in the plurality of first clamp slots respectively; and/or a plurality of second clamp slots are provided on the second end face, and the plurality of second legs are clamped in the plurality of second clamp slots respectively.

In some embodiments, an annular clamp slot is provided on an outer peripheral surface of the shell, a wear-reducing member is provided inside the annular clamp slot, and an outer peripheral surface of the wear-reducing member is higher than the outer peripheral surface of the shell.

In some aspects, a magnetorheological damper according to some embodiments of the present technology includes: a cylinder tube with a first end and a second end; and a piston assembly, in which the piston assembly is the piston assembly of the magnetorheological damper of any one of the above embodiments, the piston of the piston assembly is arranged in an inner chamber of the cylinder tube and is moveable along an axial direction of the cylinder tube, and the second end of the piston rod extends from the second end of the cylinder tube.

The piston assembly in the magnetorheological damper of the embodiments of the present technology extends an effective length of the magnetorheological fluid channel by combining radial and axial flow channels. The damping force of the magnetorheological damper increases without extending the axial length of the piston, without increasing the number of electromagnetic coils, and without increasing the power consumption of the entire machine.

In some embodiments, the magnetorheological damper further includes an gas piston, in which the gas piston is arranged in the inner chamber of the cylinder tube and is moveable along the axial direction of the cylinder tube to divide the inner chamber of the cylinder tube into a magnetorheological fluid chamber located on a first side of the gas piston and an gas chamber located on a second side of the gas piston, the cylinder tube is provided with a valve core opening connected with the gas chamber, a valve core assembly is provided at the valve core opening, and the piston of the piston assembly is movably arranged in the magnetorheological fluid chamber.

In some embodiments, the magnetorheological damper further includes a first connector and a second connector, in which the first connector is connected to the second end of the piston rod, and the second connector is connected to the first end of the cylinder tube.

In some embodiments, the magnetorheological damper further includes a buffer block, in which the buffer block is located between the first connector and the second end of the cylinder tube, and is provided on one of the first connector, the piston rod, and the second end of the cylinder tube.

In some aspects, a vehicle according to some embodiments of the present technology including: a vehicle frame; a suspension frame; and a magnetorheological damper, in which the magnetorheological damper is a magnetorheological damper of any one of the above example embodiments, and the magnetorheological damper is arranged between the vehicle frame and the suspension frame.

### BRIEF DESCRIPTION OF THE DRAWINGS

FIG. 1 is an exploded view of a piston assembly of a magnetorheological damper according to an embodiment of the present technology.

FIG. 2 is a three-dimensional view of a piston assembly of a magnetorheological damper according to an embodiment of the present technology.

FIG. 3 is an end view of a piston assembly of a magnetorheological damper according to an embodiment of the present technology.

FIG. 4 is a sectional view along a line A-A in FIG. 3.

FIG. 5 is a partially enlarged view of FIG. 4.

FIG. 6 is a sectional view along a line B-B in FIG. 3.

FIG. 7 is a partially enlarged view of FIG. 6.

FIG. 8 is a schematic diagram of a magnetic field distribution inside a piston assembly of a magnetorheological damper according to an embodiment of the present technology.

FIG. 9 is a schematic diagram of a coil bracket of a piston component of a magnetorheological damper according to an embodiment of the present technology.

FIG. 10 is an assembly schematic diagram of a coil bracket and an electromagnetic coil of a piston assembly of a magnetorheological damper according to an embodiment of the present technology.

FIG. 11 is an assembly schematic diagram of a coil bracket, an electromagnetic coil, and a main iron core of a piston assembly of a magnetorheological damper according to an embodiment of the present technology.

FIG. 12 is an assembly schematic diagram of a coil bracket, an electromagnetic coil, a main iron core, a first supporting frame, and a second supporting frame of a piston assembly of a magnetorheological damper according to an embodiment of the present technology.

FIG. 13 is an assembly schematic diagram from another perspective of a coil bracket, an electromagnetic coil, a main iron core, a first supporting frame, and a second supporting frame of a piston assembly of a magnetorheological damper according to an embodiment of the present technology.

FIG. 14 is a three-dimensional view of a piston of a piston assembly of a magnetorheological damper according to an embodiment of the present technology.

FIG. 15 is a three-dimensional view from another perspective of a piston of a piston assembly of a magnetorheological damper according to an embodiment of the present technology.

FIG. 16 is a three-dimensional view of a magnetorheological damper according to an embodiment of the present technology.

FIG. 17 is an exploded view of a magnetorheological damper according to an embodiment of the present technology.

FIG. 18 is a sectional view of a magnetorheological damper according to an embodiment of the present technology.

FIG. 19A to FIG. 19E illustrate an operation process of a magnetorheological damper according to an embodiment of the present technology.

FIG. 20 is a partial schematic diagram of a vehicle according to an embodiment of the present technology.

FIG. 21 is a partial plan view of a vehicle according to an embodiment of the present technology.

### REFERENCE SIGNS

Reference signs in the drawings include piston assembly 100, piston rod 110, lead wire through-hole 111, filling layer 112, large diameter section 113, small diameter section 114, piston 120, first axial flow channel 1201, second axial flow channel 1202, shell 121, first magnetorheological fluid inlet/outlet 1211, second magnetorheological fluid inlet/outlet 1212, sleeve 1213 for iron cores, first piston cover 1214, second piston cover 1215, first connecting hole 1216, wear-reducing member 1217, first-end iron core 122, first gap 1221, second connecting hole 1222, second-end iron core 123, second gap 1231, main iron core 124, central through-hole 1241, coil bracket 125, annular groove 1251, first side wall 1252, second side wall 1253, first through slot 1254, second through slot 1255, first end face 1256, second end face 1257, first clamp slot 1258, second clamp slot 1259, electromagnetic coil 126, first lead wire 1261, second lead wire 1262, first supporting frame 127, first leg 1271, first radial flow channel 1272, first lead wire channel 1273, first supporting tube 1274, first guide slot 1275, first pass-through slot 1276, second supporting frame 128, second leg 1281, second radial flow channel 1282, second lead wire channel 1283, second supporting tube 1284, second guide slot 1285, second pass-through slot 1286. Also, reference signs include magnetorheological damper 200, cylinder tube 210, magnetorheological fluid chamber 211, first chamber 2111, second chamber 2112, gas chamber 212, valve core opening 213, valve core assembly 214, gas piston 220, first connector 230, second connector 240, buffer block 250, guide cover 260, vehicle 300, vehicle frame 310, suspension frame 320.

### DETAILED DESCRIPTION

Embodiments of the present technology are described in detail below, and examples of embodiments are illustrated in accompanying drawings. Embodiments described below with reference to the accompanying drawings are illustrative and are intended to be used to explain the present technology and cannot be understood as limitation of the present technology.

Magnetorheological dampers are widely used for vibration control of a robot, a car, and a large civil structure. Magnetorheological fluid used in the magnetorheological dampers is a new type of intelligent material. Under an action of a magnetic field, the magnetorheological fluid can complete a transformation from a Newtonian fluid to a quasi-solid, and this process is reversible. The magnetorheological damper mainly includes an electromagnetic coil that generates a magnetic field, a magnetorheological fluid flow channel for a flow of the magnetorheological fluid, and a magnetic iron core. Conventionally, the magnetorheological fluid channel is usually formed by the electromagnetic coil and the magnetic iron core, which typically suffers from low damping force in existing magnetorheological dampers. Also, for conventional magnetorheological dampers, in order to increase the damping force, a length of a piston and a number of coils are usually increased to increase a length of the magnetorheological fluid channel in an axial direction of the piston. However, due to the increase of the length of the piston, the magnetorheological damper thus has a large volume and occupies a large space, which is undesirable for a variety of devices, systems, and techniques that employ the magnetorheological damper. In addition, existing magnetorheological dampers suffer other problems including complex configurations of lead wires of the electromagnetic coils in dampers.

The present technology is intended to solve at least one of the problems of conventional magnetorheological dampers to at least some extent.

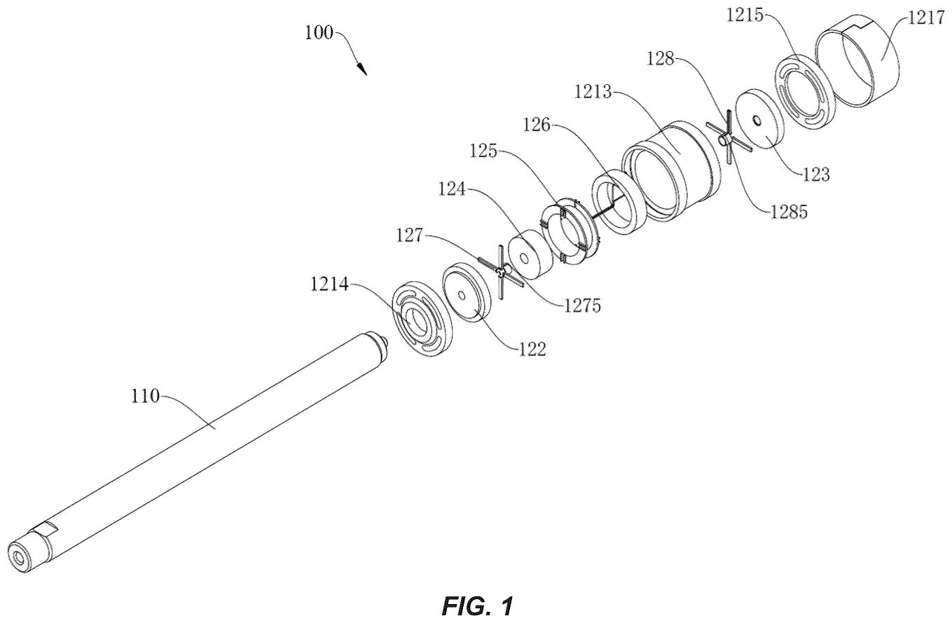

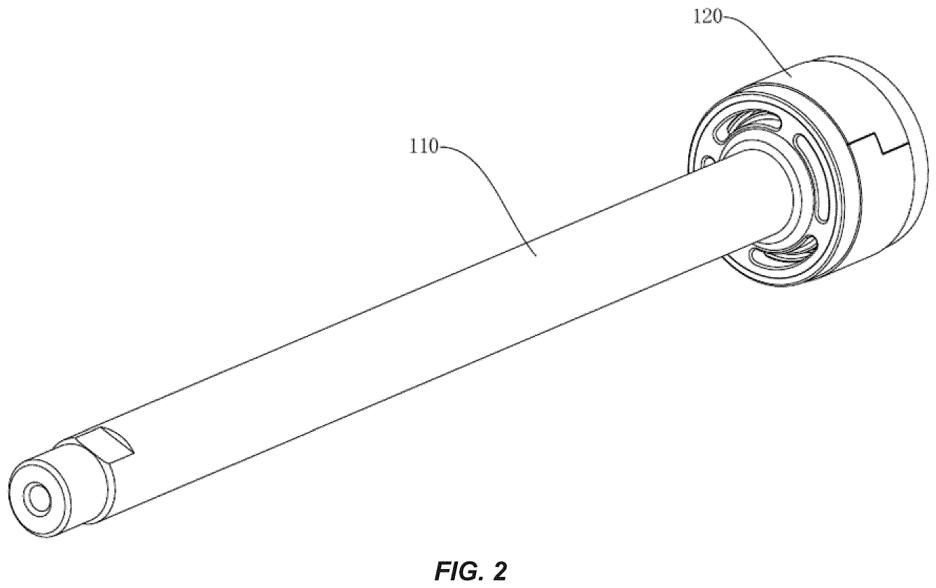

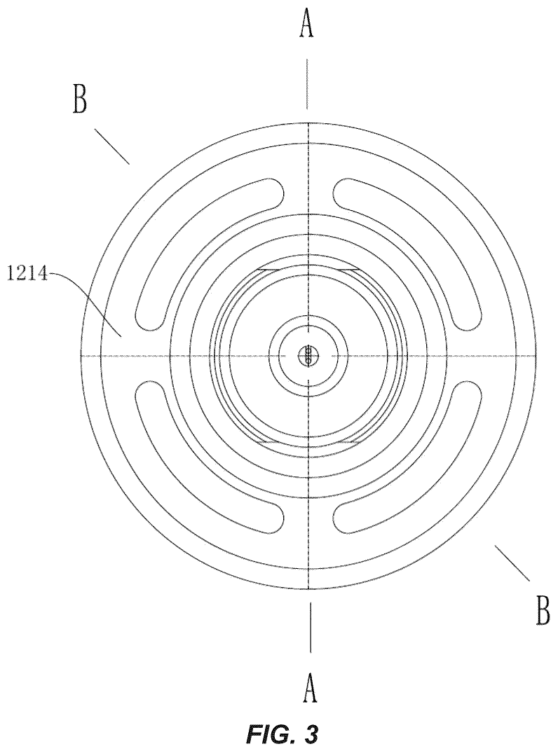

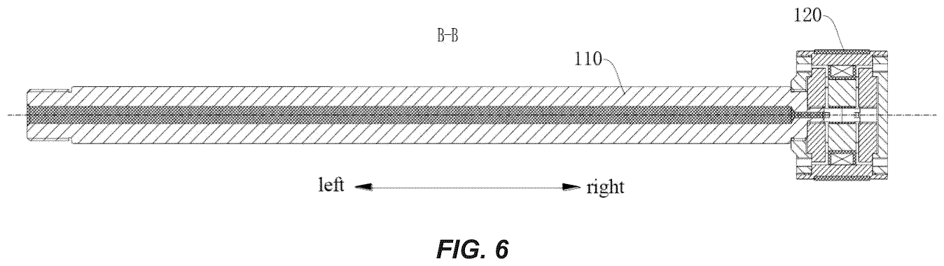

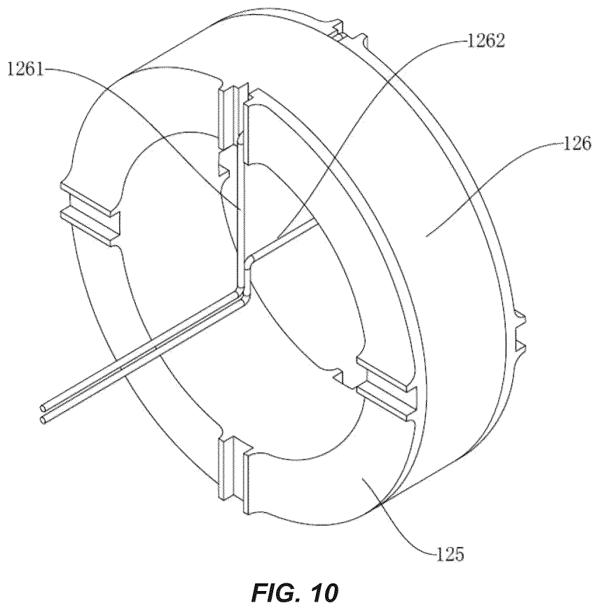

As shown in FIG. 1 to FIG. 15, a piston assembly 100 of a magnetorheological damper in the embodiments of the present technology includes a piston rod 110 and a piston 120, in which the piston rod 110 has a first end and a second end opposite to each other in an axial direction of the piston rod 110, and the piston 120 is connected to the first end of the piston rod 110.

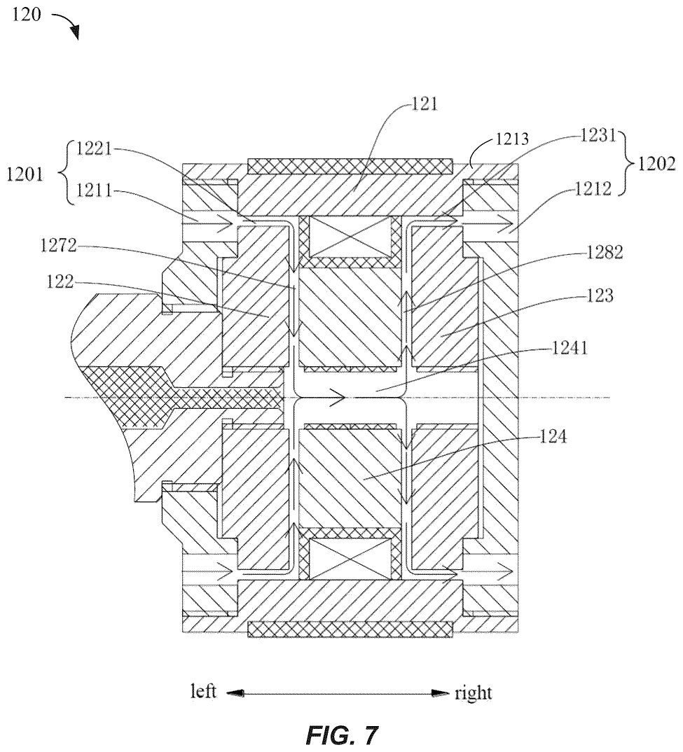

Specifically, as shown in FIG. 7 in view of FIG. 1, the piston 120 includes a shell 121, a first-end iron core 122, a second-end iron core 123, a main iron core 124, a coil bracket 125, an electromagnetic coil 126, a first supporting frame 127, and a second supporting frame 128. The first-end iron core 122, the second-end iron core 123, the main iron core 124, the coil bracket 125, the electromagnetic coil 126, the first supporting frame 127, and the second supporting frame 128 are all arranged inside the shell 121.

The shell 121 is provided with a first magnetorheological fluid inlet/outlet 1211 and a second magnetorheological fluid inlet/outlet 1212 for an inflow and outflow of magnetorheological fluid, i.e., the magnetorheological fluid can enter the shell 121 through the first magnetorheological fluid inlet/outlet 1211 and the second magnetorheological fluid inlet/outlet 1212 and can also be discharged from the shell through the first magnetorheological fluid inlet/outlet 1211 and the second magnetorheological fluid inlet/outlet 1212.

As shown in FIG. 7, there is a first gap 1221 between an outer peripheral surface of the first-end iron core 122 and an inner peripheral surface of the shell 121, and the first gap 1221 is in connection with the first magnetorheological fluid inlet/outlet 1211 to form a first axial flow channel 1201. There is a second gap 1231 between an outer peripheral surface of the second-end iron core 123 and the inner peripheral surface of the shell 121, and the second gap 1231 is in connection with the second magnetorheological fluid inlet/outlet 1212 to form a second axial flow channel 1202. It can be understood that the first gap 1221 and the second gap 1231 are both annular gaps. The first axial flow channel 1201 and the second axial flow channel 1202 both extend along an axial direction of the piston 120.

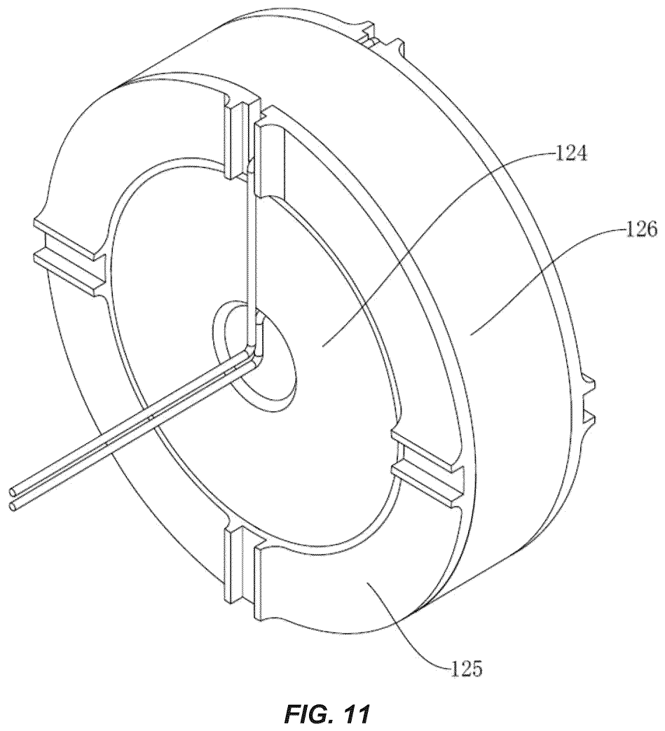

As shown in FIG. 11 in view of FIG. 7, the coil bracket 125 is sleeved on the main iron core 124, and the electromagnetic coil 126 is wound around an outer peripheral surface of the coil bracket 125. The main iron core 124 has a central through-hole 1241 and is located between the first-end iron core 122 and the second-end iron core 123 in an axial direction of the main iron core 124. The main iron core 124 is spaced from the first-end iron core 122, and the main iron core 124 is spaced from the second-end iron core 123, i.e., there is a first interval between the main iron core 124 and the first-end iron core 122, and there is a second interval between the main iron core 124 and the second-end iron core 123.

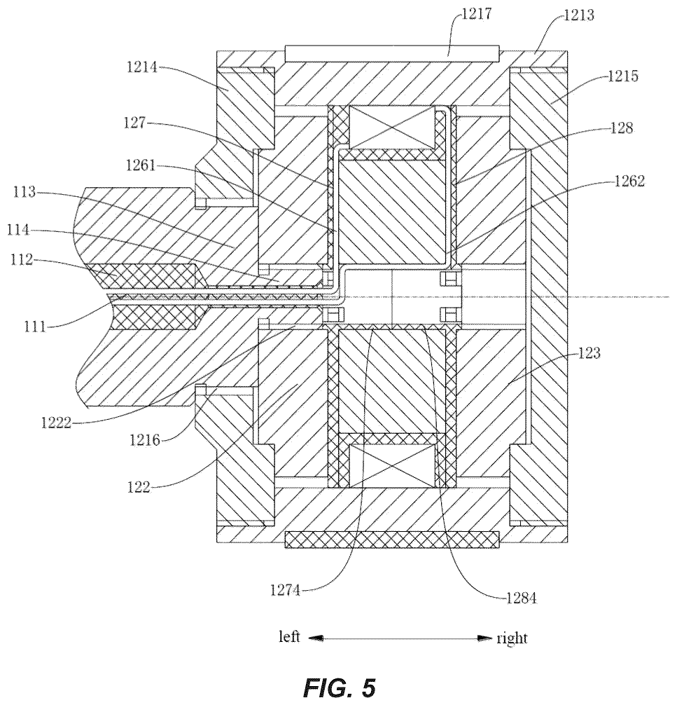

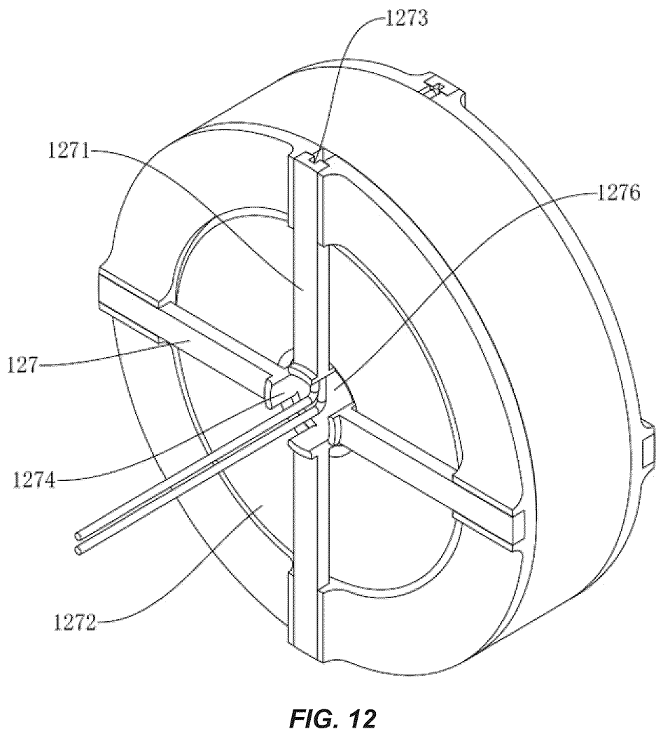

As shown in FIG. 12 in view of FIG. 5 and FIG. 7, the first supporting frame 127 includes a plurality of first legs 1271, the plurality of first legs 1271 are sandwiched between the first-end iron core 122 and the main iron core 124 and arranged radially to form a plurality of first radial flow channels 1272 between the first-end iron core 122 and the main iron core 124. The first radial flow channel 1272 is in connection with the central through-hole 1241, and the first radial flow channel 1272 is in connection with the first gap 1221. In other words, the plurality of first legs 1271 are located in the first interval, dividing the first interval into the plurality of first radial flow channels 1272 that extend along a radial direction of the main iron core 124. An inner end of the first radial flow channel 1272 (an end near the central through-hole 1241) is in connection with the central through-hole 1241, and an outer end of the first radial flow channel 1272 (an end near the inner peripheral surface of the shell 121) is in connection with the first gap 1221, i.e., connected with the first axial flow channel 1201.

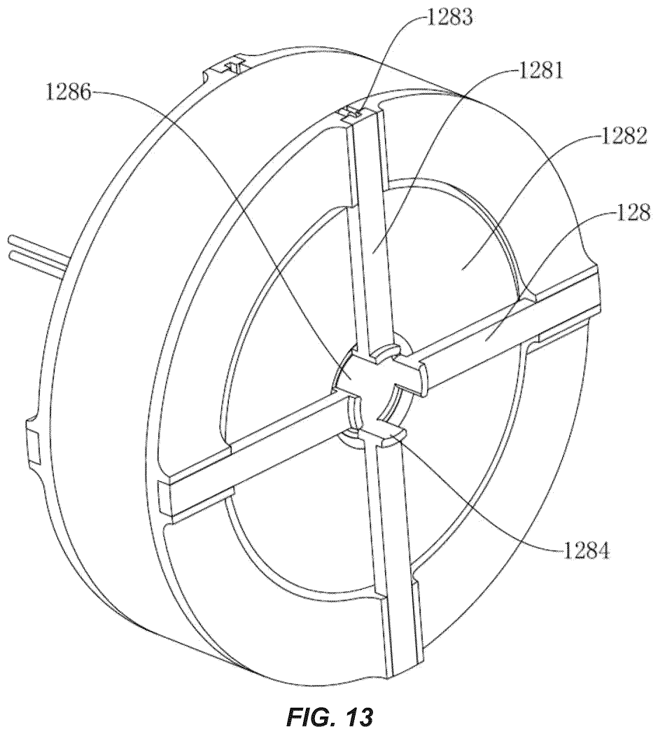

As shown in FIG. 13 in view of FIG. 5 and FIG. 7, the second supporting frame 128 includes a plurality of second legs 1281, the plurality of second legs 1281 are sandwiched between the second-end iron core 123 and the main iron core 124 and arranged radially to form a plurality of second radial flow channels 1282 in connection with the central through-hole 1241 between the second-end iron core 123 and the main iron core 124, and the second radial flow channel 1282 is in connection with the second gap 1231. In other words, the plurality of second legs 1281 are located in the second interval, dividing the second interval into the plurality of second radial flow channels 1282 that extend along a radial direction of the main iron core 124. An inner end of the second radial flow channel 1282 (an end near the central through-hole 1241) is in connection with the central through-hole 1241, and an outer end of the second radial flow channel 1282 (an end near the inner peripheral surface of the shell 121) is in connection with the second gap 1231, i.e., connected with the second axial flow channel 1202.

Thus, referring back to FIG. 7, the first axial flow channel 1201, the first radial flow channel 1272, the central through-hole 1241, the second radial flow channel 1282, and the second axial flow channel 1202 are sequentially in connection with forming a magnetorheological fluid flow channel of the piston 120.

The magnetorheological fluid produces a coagulation effect under an action of a magnetic field, which increases a viscosity of the magnetorheological fluid and increases a resistance for the magnetorheological fluid through the magnetorheological fluid flow channel, resulting in a damping effect. By adjusting a current magnitude, a magnetic field strength of the electromagnetic coil 126 can be changed, thereby the viscosity of the magnetorheological fluid in the magnetorheological fluid flow channel is adjusted, achieving an adjustment of damping force.

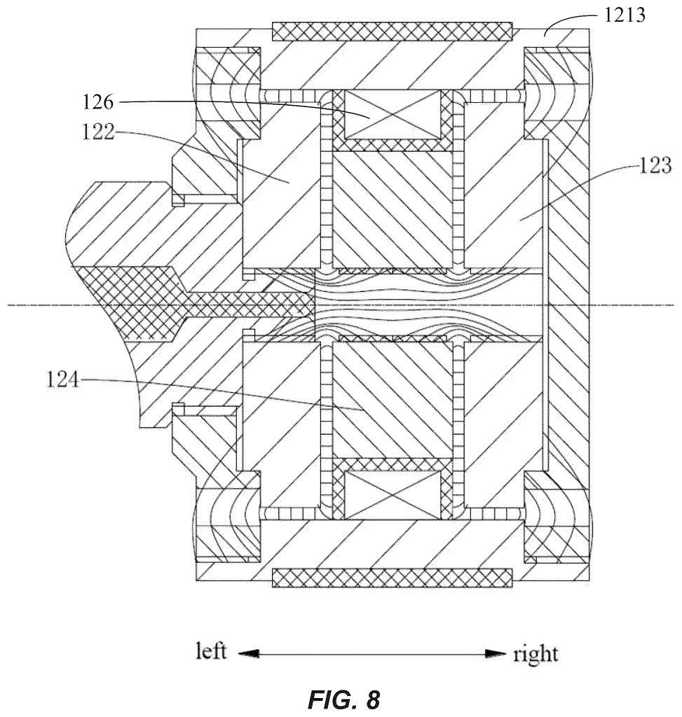

FIG. 8 shows a schematic diagram of the magnetic field distribution inside the piston assembly 100, and the electromagnetic coil 126 generates a magnetic field when energized, magnetizing the main iron core 124, the first-end iron core 122, the second-end iron core 123, and the shell 121. The main iron core 124, the first-end iron core 122, the second-end iron core 123, and the shell 121 are magnetized and generate a magnetic field in the magnetorheological fluid flow channel.

When the magnetorheological fluid enters the first axial flow channel 1201 from the first magnetorheological fluid inlet/outlet 1211, the magnetorheological fluid flows out from the second magnetorheological fluid inlet/outlet 1212 sequentially through the first axial flow channel 1201, the first radial flow channel 1272, the central through-hole 1241, the second radial flow channel 1282, and the second axial flow channel 1202. When the magnetorheological fluid enters the second axial flow channel 1202 from the second magnetorheological fluid inlet/outlet 1212, the magnetorheological fluid flows out from the first magnetorheological fluid inlet/outlet 1211 sequentially through the second axial flow channel 1202, the second radial flow channel 1282, the central through-hole 1241, the first radial flow channel 1272, and the first axial flow channel 1201.

The piston assembly of the magnetorheological damper in the embodiments of the present technology effectively utilizes an internal space of the shell of the piston and extends an effective length of the magnetorheological fluid channel by combining radial and axial flow channels. A requirement of increasing the damping force is achieved without extending an axial length of the piston, without increasing the number of electromagnetic coils, and without increasing a power consumption of an entire machine. It can also be said that under a condition of a same damping force, the axial length of the piston in the embodiments of the present technology can be greatly shortened, reducing a volume of the piston. In addition, the magnetorheological fluid channel is only provided inside the piston, which does not affect a structural strength of the piston rod.

Therefore, the piston assembly of the embodiments of the present technology has advantages of high structural strength, compact structure, and small volume.

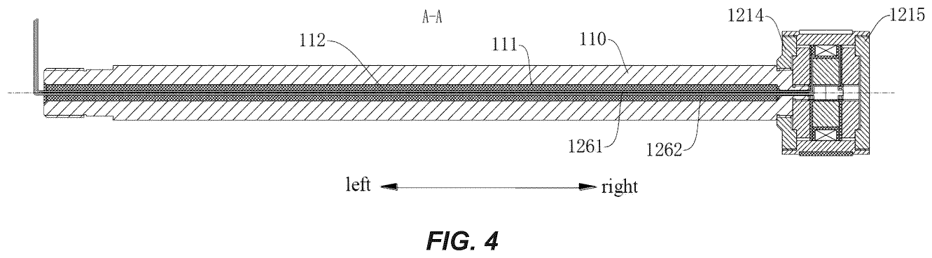

In some embodiments, as shown in FIG. 1 to FIG. 15, the shell 121 includes a sleeve 1213 for iron cores, a first piston cover 1214, and a second piston cover 1215. The first piston cover 1214 is arranged at a first end (such as a left end in FIG. 4 to FIG. 7) of the sleeve 1213 for iron cores and is connected to the piston rod 110. As shown in FIG. 7, the first magnetorheological fluid inlet/outlet 1211 is provided on the first piston cover 1214 and is aligned with the first gap 1221 in an axial direction of the sleeve 1213 for iron cores. The first magnetorheological fluid inlet/outlet 1211 forms the first axial flow channel 1201 with the first gap 1221, and the magnetorheological fluid flows in the first axial flow channel 1201 along an axial direction of the shell 121.

The second piston cover 1215 is arranged at a second end (such as a right end in FIG. 4 to FIG. 7) of the sleeve 1213 for iron cores and is connected to the piston rod 110. As shown in FIG. 7, the second magnetorheological fluid inlet/outlet 1212 is provided on the second piston cover 1215 and is aligned with the second gap 1231 in the axial direction of the sleeve 1213 for iron cores. The second magnetorheological fluid inlet/outlet 1212 forms the second axial flow channel 1202 with the second gap 1231, and the magnetorheological fluid flows in the second axial flow channel 1202 along an axial direction of the shell 121.

It should be noted that, in some embodiments, for example, the sleeve 1213 for iron cores is made of magnetic material, while the first piston cover 1214 and the second piston cover 1215 are made of non-magnetic material that does not participate in magnetization to form a magnetic field.

In some specific examples, a plurality of the first magnetorheological fluid inlet/outlet 1211 are provided (for example, in the example shown in FIG. 1 to FIG. 15, the number of first magnetorheological fluid inlet/outlet 1211 is four), and the plurality of first magnetorheological fluid inlet/outlet 1211 are spaced in a circumferential direction of the first piston cover 1214 and are aligned with the annular first gap 1221 in the axial direction of the sleeve 1213 for iron cores.

The magnetorheological fluid can enter the first gap 1221 from the plurality of first magnetorheological fluid inlets/outlets 1211 and then disperse into the plurality of first radial flow channels 1272, or the magnetorheological fluid in the first gap 1221 can be dispersedly discharged from the piston 120 from the plurality of first magnetorheological fluid inlets/outlets 1211.

A plurality of the second magnetorheological fluid inlet/outlet 1212 are provided (for example, in the example shown in FIG. 1 to FIG. 15, the number of first magnetorheological fluid inlet/outlet 1211 is four), and the plurality of second magnetorheological fluid inlet/outlet 1212 are spaced in the circumferential direction of the second piston cover 1215 and are aligned with the annular first gap 1221 in the axial direction of the sleeve 1213 for iron cores. The magnetorheological fluid can enter the second gap 1231 from the plurality of second magnetorheological fluid inlets/outlets 1212 and then disperse into the plurality of second radial flow channels 1282, or the magnetorheological fluid in the second gap 1231 can be dispersedly discharged from the piston 120 from the plurality of second magnetorheological fluid inlets/outlets 1212.

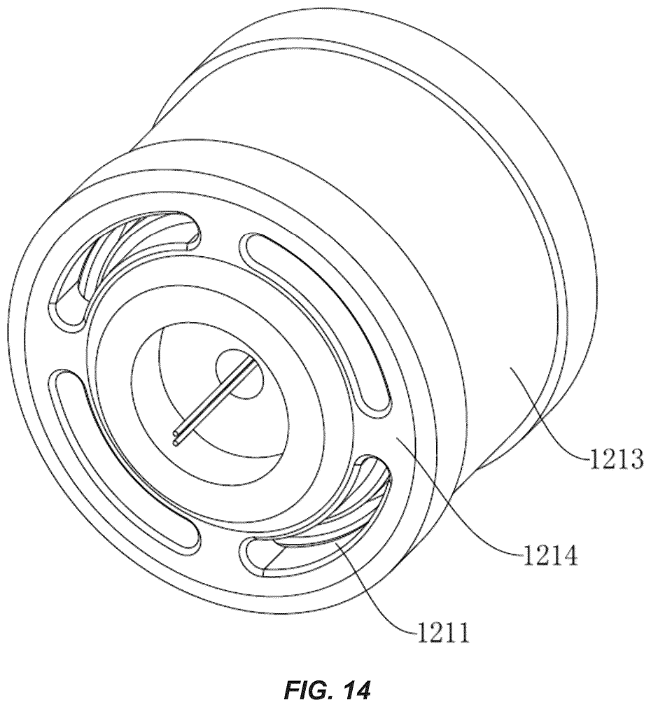

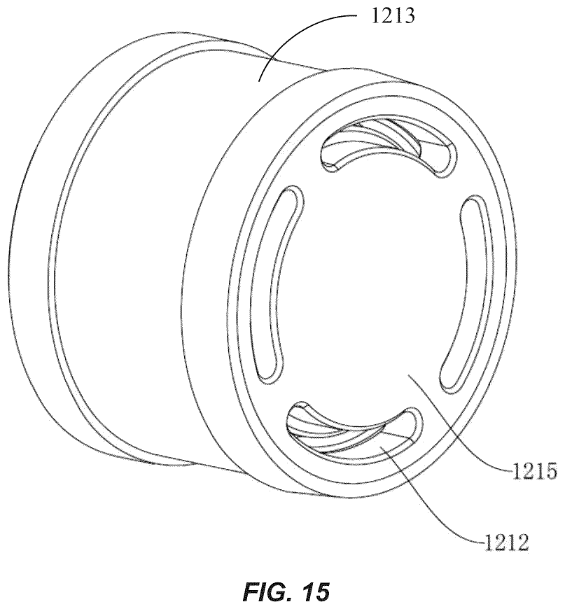

Furthermore, as shown in FIG. 14 and FIG. 15, the first magnetorheological fluid inlet/outlet 1211 is arc-shaped, extending along a circumferential direction of the first piston cover 1214 to match the annular first gap 1221. At the same time, the arc-shaped first magnetorheological fluid inlet/outlet 1211 has a larger cross-sectional area, allowing the magnetorheological fluid to flow smoothly. The second magnetorheological fluid inlet/outlet 1212 is arc-shaped, extending along the circumferential direction of the second piston cover 1215 to match the annular second gap 1231. At the same time, the arc-shaped second magnetorheological fluid inlet/outlet 1212 has a larger cross-sectional area, allowing the magnetorheological fluid to flow smoothly.

Optionally, the plurality of first magnetorheological fluid inlets/outlets 1211 correspond to the plurality of first radial flow channels 1272 in the axial direction of the shell 121, and the plurality of second magnetorheological fluid inlets/outlets 1212 correspond to the plurality of second radial flow channels 1282 in the axial direction of the shell 121, resulting in smoother flow of magnetorheological fluid. For example, as shown in FIG. 1 to FIG. 15, the number of the first magnetorheological fluid inlet/outlet 1211, the number of the first radial flow channel 1272, the number of the second magnetorheological fluid inlet/outlet 1212, and the number of the second radial flow channel 1282 are all four. In this example, the four first magnetorheological fluid inlets/outlets 1211 can correspond one-to-one with the four first radial flow channels 1272 in the axial direction of the shell 121, and the four second magnetorheological fluid inlets/outlets 1212 correspond one-to-one with the four second radial flow channels 1282 in the axial direction of the shell 121.

In some embodiments, as shown in FIG. 4 and FIG. 5, a first end of the shell 121 is provided with a first connecting hole 1216 (for example, in FIG. 5, the first connecting hole 1216 is provided on the first piston cover 1214 of the shell 121), and the first-end iron core 122 is provided with a second connecting hole 1222. The first connecting hole 1216, the second connecting hole 1222, and the central through-hole 1241 of the main iron core 124 are aligned centrally in an axial direction of the main iron core 124, and the first end of the piston rod 110 is connected inside the first connecting hole 1216 and the second connecting hole 1222.

Specifically, as shown in FIG. 5, a diameter of the first connecting hole 1216 is greater than a diameter of the second connecting hole 1222. The first end of the piston rod 110 has a large diameter section 113 and a small diameter section 114. The large diameter section 113 of the piston rod 110 is matched in the first connecting hole 1216, and the small diameter section 114 of the piston rod 110 is matched in the second connecting hole 1222. Optionally, the large diameter section 113 is threaded to the first connecting hole 1216, and the small diameter section 114 is threaded to the second connecting hole 1222.

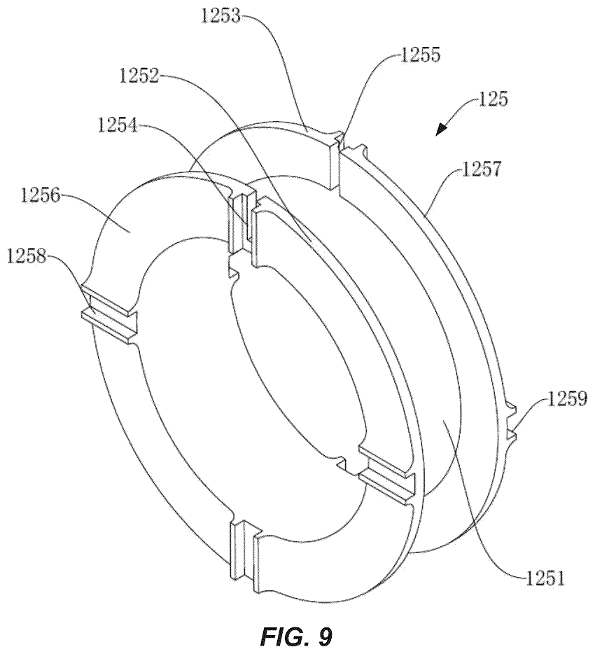

In some embodiments, as shown in FIG. 9 to FIG. 13, an annular groove 1251 is provided on an outer peripheral surface of the coil bracket 125, and a coil body of the electromagnetic coil 126 is arranged inside the annular groove 1251. The annular groove 1251 is configured to limit a position of the coil body of the electromagnetic coil 126 and prevent the coil body of the electromagnetic coil 126 from displacing. The electromagnetic coil 126 includes a first lead wire 1261 and a second lead wire 1262, with the first lead wire 1261 and second lead wire 1262 extending from the coil body, wrapped around the coil bracket 125, of the electromagnetic coil 126. The first lead wire 1261 and the second lead wire 1262 are configured to connect with an external power source and energize, thereby adjusting a current in the electromagnetic coil 126 to change a magnetic field strength.

Specifically, as shown in FIG. 9 to FIG. 13, the annular groove 1251 has a first side wall 1252 and a second side wall 1253. A first through slot 1254 is provided on the first side wall 1252, and a second through slot 1255 is provided on the second side wall 1253. The first lead wire 1261 of the electromagnetic coil 126 passes through the first through slot 1254 and extends outward, and the second lead wire 1262 passes through the second through slot 1255 and extends outward.

As shown in FIG. 5, FIG. 9, and FIG. 12, the first through slot 1254 is aligned with one first leg 1271 in the plurality of the first legs 1271 of the first supporting frame 127. The first leg 1271 is provided with a first lead wire channel 1273 extending along a length direction of the first leg 1271. After passing through the first through slot 1254 and extending outward, the first lead wire 1261 extends inward along a radial direction of the main iron core 124 through the first lead wire channel 1273 and extends to the central through-hole 1241 of the main iron core 124 and then extends outward.

As an example, as shown in FIG. 1 to FIG. 15, the first lead wire channel 1273 is a through slot provided on a side surface, facing the main iron core 124, of the first leg 1271. Optionally, the first lead wire channel 1273 is a through-hole provided within the first leg 1271.

As shown in FIG. 5, FIG. 9, and FIG. 13, the second through slot 1255 is aligned with one second leg 1281 in the plurality of second legs 1281 of the second supporting frame 128. The second leg 1281 is provided with a second lead wire channel 1283 extending along a length direction of the second legs 1281. After passing through the second through slot 1255 and extending outward, the second lead wire 1262 extends inward along a radial direction of the main iron core 124 through the second lead wire channel 1283 and then extends outward by passing through the central through-hole 1241 of the main iron core 124.

As an example, as shown in FIG. 1 to FIG. 15, the second lead wire channel 1283 is a through slot provided on a side surface, facing the main iron core 124, of the second leg 1281. Optionally, the second lead wire channel 1283 is a through-hole provided within the second leg 1281.

Furthermore, as shown in FIG. 1 to FIG. 8, a lead wire through-hole 111 extending along an axial direction of the piston rod 110 is provided inside the piston rod 110, and the lead wire through-hole 111 is aligned with the central through-hole 1241 of the main iron core 124 in the axial direction. The first lead wire 1261 and the second lead wire 1262 extend from the central through-hole 1241 of the main iron core 124 and then extend outward through the lead wire through-hole 111. For example, as shown in FIG. 5, the first lead wire 1261 and the second lead wire 1262 extend to the left along the lead wire through-hole 111.

As shown in FIG. 4 and FIG. 5, in order to prevent a movement of the first lead wire 1261 and the second lead wire 1262, a filling layer 112 is filled inside the lead wire through-hole 111. The filling layer 112 is filled in a gap between the first lead wire 1261, the second lead wire 1262, and a hole wall surface of the lead wire through-hole 111 to prevent the first lead wire 1261 and the second lead wire 1262 from colliding with each other or colliding with the hole wall surface of the lead wire through-hole 111, causing a damage of the lead wire and affecting power supply. The filling layer 112 also plays a sealing role.

Optionally, the filling layer 112 is made of sponge material or other filling materials that can provide cushioning and sealing effects.

In some embodiments, as shown in FIG. 1 to FIG. 15, the first supporting frame 127 includes a first supporting tube 1274, and the plurality of first legs 1271 are spaced in a circumferential direction of the first supporting tube 1274 and connected to an outer peripheral surface of the first supporting tube 1274. A part of the first supporting tube 1274 is matched in the central through-hole 1241 of the main iron core 124 to assemble the first supporting frame 127 with the main iron core 124.

The second supporting frame 128 includes a second supporting tube 1284, and the plurality of second legs 1281 are spaced in a circumferential direction of the second supporting tube 1284 and connected to an outer peripheral surface of the second supporting tube 1284. A part of the second supporting tube 1284 is matched in the central through-hole 1241 of the main iron core 124 to assemble the second supporting frame 128 with the main iron core 124.

The first supporting tube 1274 contacts with the second supporting tube 1284 in the central through-hole 1241 to position the relative locations of the first supporting frame 127 and the second supporting frame 128.

In the examples shown in FIG. 1 to FIG. 15, the plurality of first legs 1271 extend outward from the first supporting tube 1274 along a radial direction of the first supporting tube 1274. The fan-shaped first radial flow channel 1272 is formed between adjacent first legs 1271 in a circumferential direction of the first supporting tube 1274. The first supporting tube 1274 is provided with a plurality of first pass-through slots 1276 that pass through a tube wall of the first supporting tube 1274, and the plurality of first pass-through slots 1276 correspond one-to-one with the plurality of first radial flow channels 1272. The first pass-through slot 1276 is configured to connect the corresponding first radial flow channel 1272 with the central through-hole 1241. The magnetorheological fluid can flow into the central through-hole 1241 through the first pass-through slot 1276 from the first radial flow channel 1272 or into the first radial flow channel 1272 through the first pass-through slot 1276 from the central through-hole 1241.

The plurality of second legs 1281 extend outward from the second supporting tube 1284 along a radial direction of the second supporting tube 1284. The fan-shaped second radial flow channel 1282 is formed between adjacent second legs 1281 in a circumferential direction of the second supporting tube 1284. The second supporting tube 1284 is provided with a plurality of second pass-through slots 1286 that pass through a tube wall of the second supporting tube 1284, and the plurality of second pass-through slots 1286 correspond one-to-one with the plurality of second radial flow channels 1282. The second pass-through slot 1286 is configured to connect the corresponding second radial flow channel 1282 with the central through-hole 1241. The magnetorheological fluid can flow into the central through-hole 1241 through the second pass-through slot 1286 from the second radial flow channel 1282 or into the second radial flow channel 1282 through the second pass-through slot 1286 from the central through-hole 1241.

As shown in FIG. 1, FIG. 5, and FIG. 9, a first guide slot 1275 extending along an axial direction of the first supporting tube 1274 is provided on the first supporting tube 1274. A second guide slot 1285 extending an axial direction of the second supporting tube 1284 is provided on the second supporting tube 1284. The first guide slot 1275 is aligned with the second guide slot 1285 in the axial direction of the central through-hole 1241 to guide the second lead wire 1262 of the electromagnetic coil 126 to pass through the central through-hole 1241 of the main iron core 124. Then, the second lead wire 1262 and the first lead wire 1261 extend outward by passing through jointly the lead wire through-hole 111 in the piston rod 110. In other words, a segment of the second lead wire 1262 located in the central through-hole 1241 is matched with the first guide slot 1275 and the second guide slot 1285. The first guide slot 1275 and the second guide slot 1285 are provided to prevent the second lead wire 1262 from floating in the central through-hole 1241 and affecting the flow of magnetorheological fluid, thereby improving an assembly stability of internal components of the piston assembly 100.

In order to extend the second lead wire 1262 more smoothly, for example, as shown in FIG. 5, the second guide slot 1285 provided on the second supporting tube 1284 is adjacent to the second lead wire channel 1283 and is in connection with the second lead wire channel 1283. The second lead wire 1262 extends along the second lead wire channel 1283 and enters the second guide slot 1285 at a shorter distance, reducing a length of an exposed section of the second lead wire 1262 and further improving the assembly stability of the internal components of the piston assembly 100.

In some embodiments, as shown in FIG. 9 to FIG. 13, the coil bracket 125 has a first end face 1256 and a second end face 1257 opposite to the first end face 1256 in an axial direction of the coil bracket 125. The first leg 1271 of the first supporting frame 127 is in contact with the first end face 1256, and an outer end face of the first leg 1271 is flush with an outer circumferential edge of the first end face 1256 to maximize a length of the first radial flow channel 1272 defined by the first leg 1271. The second leg 1281 of the second supporting frame 128 is in contact with the second end face 1257, and an outer end face of the second leg 1281 is flush with an outer circumferential edge of the second end face 1257 to maximize a length of the second radial flow channel 1282 defined by the second leg 1281.

As an example, as shown in FIG. 9 to FIG. 13, a plurality of first clamp slots 1258 are provided on the first end face 1256, and the plurality of first legs 1271 are clamped in the plurality of first clamp slots 1258 respectively to assemble the first supporting frame 127 with the coil bracket 125, improving the assembly stability between the first supporting frame 127 and the coil bracket 125. A plurality of second clamp slots 1259 are provided on the second end face 1257, and the plurality of second legs 1281 are clamped in the plurality of second clamp slots 1259 respectively to assemble the second supporting frame 128 with the coil bracket 125, improving the assembly stability between the second supporting frame 128 and the coil bracket 125.

Optionally, other methods may be used to assemble the first supporting frame 127 with the coil bracket 125 and assemble the second supporting frame 128 with the coil bracket 125, and the present technology does not limit this.

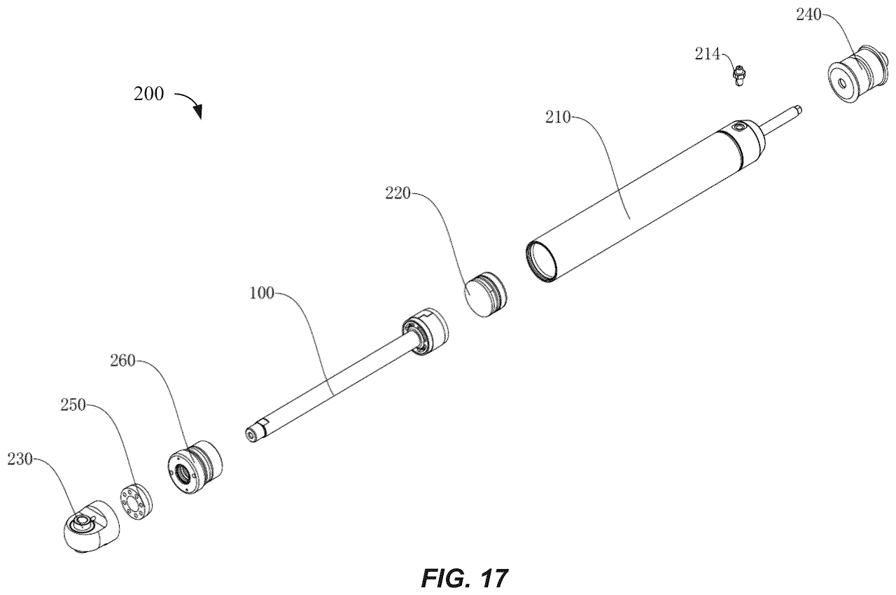

In some embodiments, as shown in FIG. 1 to FIG. 18, an annular clamp slot can be provided on an outer peripheral surface of the shell 121, and a wear-reducing member 1217 can be provided inside the annular clamp slot. For example, an outer peripheral surface of the wear-reducing member 1217 is higher than the outer peripheral surface of the shell 121. The wear-reducing member 1217 can be configured to be between the piston 120 and an inner wall of a cylinder tube 210, e.g., playing a guiding and sealing role and reducing friction.

When assembling the piston assembly 100 of the embodiments of the present technology, the electromagnetic coil 126 can be first installed on the coil bracket 125 and the first lead wire 1261 and the second lead wire 1262 can extend from the annular groove 1251 of the coil bracket 125. Then the main iron core 124, the first supporting frame 127, and the second supporting frame 128 are installed in sequence, in which the first supporting tube 1274 of the first supporting frame 127 is in contact with the second supporting tube 1284 of the second supporting frame 128.

The first lead wire 1261 extends along the first lead wire channel 1273 of the first supporting frame 127, and the second lead wire 1262 extends along the second lead wire channel 1283 of the second supporting frame 128. Moreover, the second lead wire 1262 passes through the central through-hole 1241 of the main iron core 124 along the second guide slot 1285 of the second supporting tube 1284 and the first guide slot 1275 of the first supporting tube 1274.

The first-end iron core 122 and the second-end iron core 123 are installed, and the first lead wire 1261 and the second lead wire 1262 extend from the second connecting hole 1222 of the first-end iron core 122. The sleeve 1213 for iron cores, the first piston cover 1214, and the second piston cover 1215 are installed, and the first lead wire 1261 and the second lead wire 1262 extend from the first connecting hole 1216 of the first piston cover 1214.

The piston rod 110 is connected to the piston 120, and the first lead wire 1261 and the second lead wire 1262 extend outward along the lead wire through-hole 111 of the piston rod 110. The wear-reducing member 1217 is installed on an outer side of the shell 121.

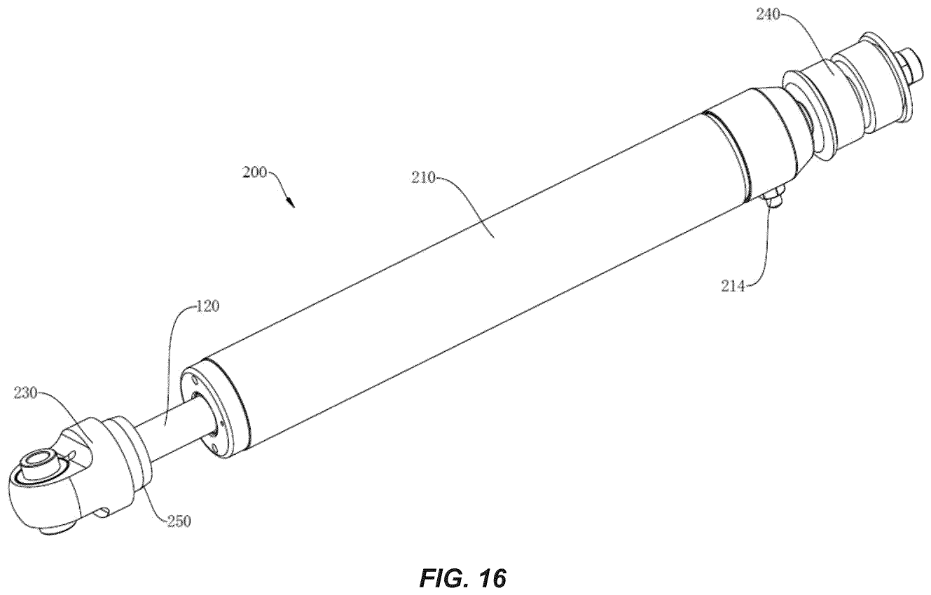

The magnetorheological damper 200 of embodiments of the present technology is described below based on FIG. 16 to FIG. 19. The magnetorheological damper 200 includes a cylinder tube 210 and a piston assembly, in which the piston assembly is the piston assembly 100 in any of the above embodiments.

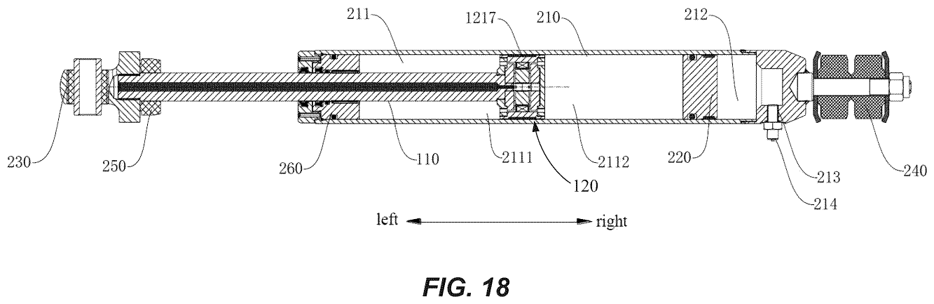

The cylinder tube 210 has a first end (such as a right end in FIG. 18) and a second end (such as a left end in FIG. 18). The piston 120 of the piston assembly 100 is arranged in an inner chamber of the cylinder tube 210 and is movable along an axial direction of the cylinder tube 210. The first end of the piston rod 110 (such as a right end in FIG. 18) is connected to the piston 120, and the second end of the piston rod 110 (such as a left end in FIG. 18) extends from the second end of the cylinder tube 210.

The piston assembly in the magnetorheological damper of the embodiments of the present technology extends an effective length of the magnetorheological fluid channel by combining radial and axial flow channels. The damping force of the magnetorheological damper increases without extending the axial length of the piston, without increasing the number of electromagnetic coils, and without increasing the power consumption of the entire machine.

In some embodiments, as shown in FIG. 16 to FIG. 19, the magnetorheological damper 200 further includes a gas piston 220, which is arranged in the inner chamber of the cylinder tube 210 and is movable along the axial direction of the cylinder tube 210 to divide the inner chamber of the cylinder tube 210 into a magnetorheological fluid chamber 211 located on a first side (such as a left side in FIG. 18) of the gas piston 220 and a gas chamber 212 located on a second side (such as a right side in FIG. 18) of the gas piston 220. The gas chamber 212 can be filled with nitrogen gas. A valve core opening 213 in connection with the gas chamber 212 is provided on the cylinder tube 210, and a valve core assembly 214 controlling inflation into the gas chamber 212 is provided at the valve core opening 213. The piston 120 of the piston assembly 100 is movably arranged in the magnetorheological fluid chamber 211.

The gas piston 220 blocks the magnetorheological fluid chamber 211 and the gas chamber 212. When the magnetorheological damper 200 is in operation, the gas piston 220 moves in the cylinder tube 210, and a volume ratio of the magnetorheological fluid chamber 211 and the gas chamber 212 changes, which can convert a gas pressure in the gas chamber 212 into a hydraulic pressure, provide a restoring force for the piston rod 110 of the piston assembly 100, and ensure that a pressure of the magnetorheological fluid in the cylinder tube 210 is always higher than a gasification critical value of the magnetorheological fluid, suppressing oil gasification.

In some embodiments, as shown in FIG. 16 to FIG. 18, the magnetorheological damper 200 further includes a first connector 230 and a second connector 240. The first connector 230 is connected to the second end of the piston rod 110 to connect with a first shock absorber, and the second connector 240 is connected to the first end of the cylinder tube 210 to connect with a second shock absorber. The magnetorheological damper 200 acts between the first shock absorber and the second shock absorber and uses a flow damping of the magnetorheological fluid to consume impact energy to achieve damping and shock absorption.

Optionally, the first connector 230 is a suspension frame connector, the first shock absorber is a suspension frame of a vehicle, and the suspension frame connector is configured to connect to the suspension frame of the vehicle.

Optionally, the second connector 240 is a vehicle frame connector, the second shock absorber is a vehicle frame of a vehicle, and the vehicle frame connector is configured to connect to the vehicle frame of the vehicle.

In some embodiments, the magnetorheological damper 200 also includes a buffer block 250, in which the buffer block 250 is located between the first connector 230 and the second end of the cylinder tube 210 and is provided on one of the first connector 230, the piston rod 110, and the second end of the cylinder tube 210. The buffer block 250 is configured to reduce an impact and limit a position when the magnetorheological damper 200 is compressed to an extreme position, avoiding a direct collision between the first connector 230 and the second end of the cylinder tube 210, in which the direct collision may cause component damage.

As an example, as shown in FIG. 16 to FIG. 18, the buffer block 250 is sleeved on the piston rod 110 and connected to the first connector 230. When the magnetorheological damper 200 is compressed, the first connector 230 moves toward the second end of the cylinder tube 210, and the buffer block 250 contacts the second end of the cylinder tube 210 to play a buffer role.

Optionally, the buffer block 250 can also be sleeved on the piston rod 110 and connected to the second end of the cylinder tube 210.

As shown in FIG. 16 to FIG. 18, the magnetorheological damper 200 further includes a guide cover 260, in which the guide cover 260 is provided at the second end of the cylinder tube 210. The piston rod 110 extends outward through a middle through-hole of the guide cover 260, and the piston rod 110 is movable and sealed with the guide cover 260. The guide cover 260 provides guidance for an axial movement of the piston rod 110 while sealing the second end of the cylinder tube 210.

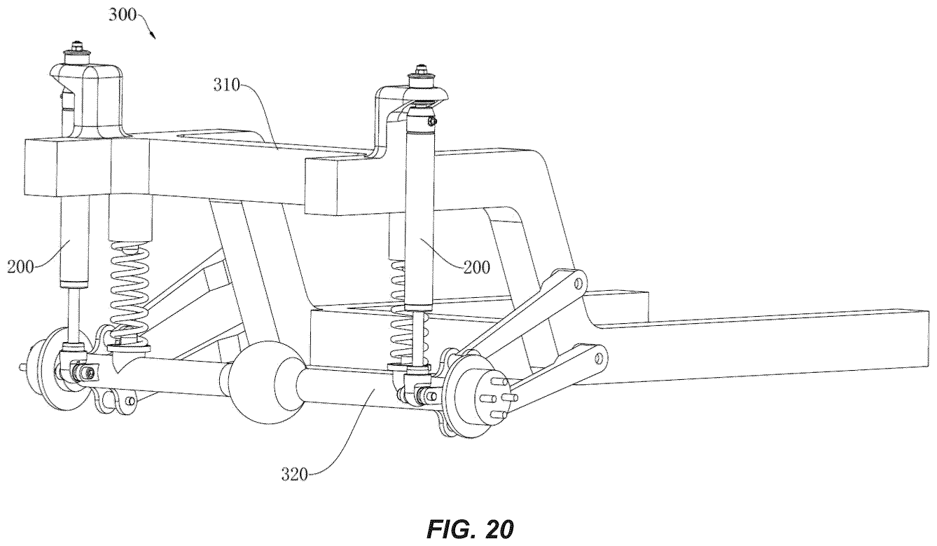

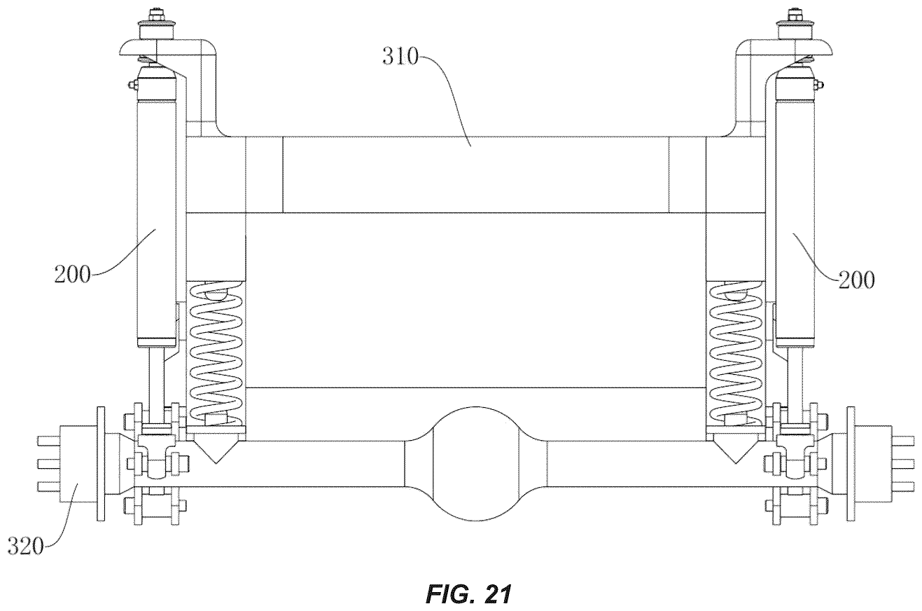

As shown in FIG. 20 and FIG. 21, a vehicle 300 of the embodiments of the present technology includes a vehicle frame 310, a suspension frame 320, and a magnetorheological damper. The magnetorheological damper is the magnetorheological damper 200 in any of the above embodiments, and the magnetorheological damper 200 is arranged between the vehicle frame 310 and the suspension frame 320 and plays a damping and shock-absorbing role.

When the vehicle 300 passes through a bumpy road surface, an impact from the road surface causes the suspension frame 320 to continuously jump, thereby driving the piston rod 110 of magnetorheological damper 200 to continuously expand and contract relative to the cylinder tube 210. During this process, the magnetorheological fluid in the magnetorheological fluid chamber 211 of the cylinder tube 210 repeatedly flows through the magnetorheological fluid flow channel in the piston 120. The damping force generated by the magnetorheological fluid continuously consumes an impact jump so that the vehicle 300 remains stable.

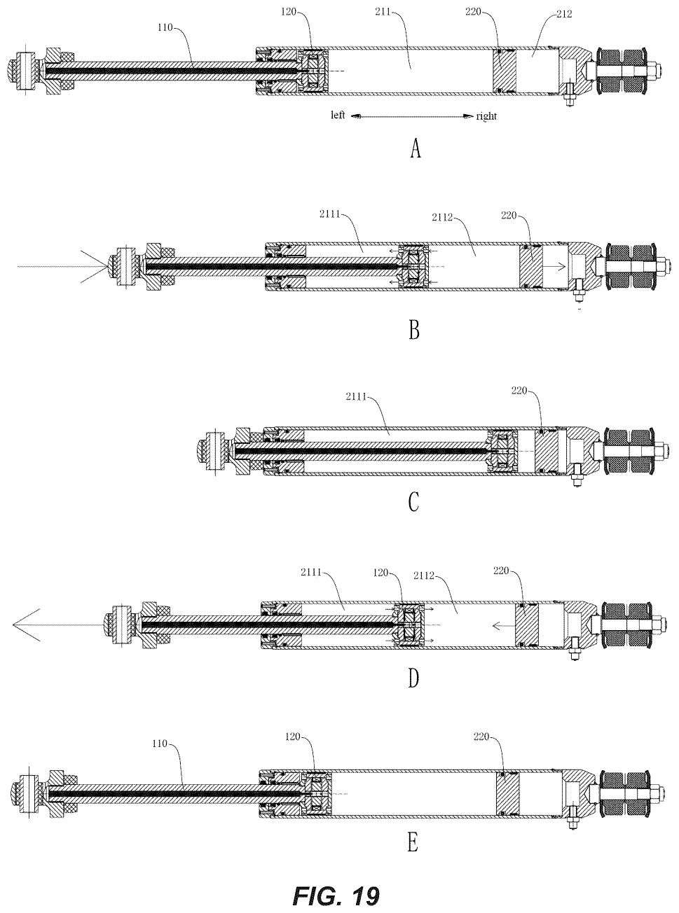

The compression and restoration process of the magnetorheological damper 200 in the embodiments of the present technology is described in detail below with reference to FIG. 19A to FIG. 19E, as well as FIG. 20 and FIG. 21.

As shown in FIG. 20 and FIG. 21, the first connector 230 (the suspension frame connector) of the magnetorheological damper 200 is hinged with a shackle on the suspension frame 320, and the second connector 240 (the vehicle frame connector) of the magnetorheological damper 200 is connected to the vehicle frame 310.

A fully restored state of the magnetorheological damper 200 is shown in FIG. 19A. At this time, the piston rod 110 is in a longest extended state, the piston 120 is located at a leftmost end of the magnetorheological fluid chamber 211, and a volume of the gas chamber 212 is in a maximum state.

As shown in FIG. 19B, when the vehicle 300 is bumpy, the piston rod 110 is compressed by force and pushes the piston 120 to the right. A part of the magnetorheological fluid chamber 211 located on a left side of the piston 120 is a first chamber 2111, and a part located on a right side of the piston 120 is a second chamber 2112. During a movement of the piston 120 to the right, the magnetorheological fluid in the second chamber 2112 enters the piston 120 from the second magnetorheological fluid inlet/outlet 1212 and sequentially flows through the second axial flow channel 1202, the second radial flow channel 1282, the central through-hole 1241, the first radial flow channel 1272, and the first axial flow channel 1201 and then flows out from the first magnetorheological fluid inlet/outlet 1211 and flows into the first chamber 2111. At the same time, the gas piston 220 moves to the right to compress the gas chamber 212, the volume of the gas chamber 212 reduces, and a volume of the magnetorheological fluid chamber 211 increases.

As shown in FIG. 19C, the piston rod 110 is compressed to its extreme position under force, and the buffer block 250 contacts with the guide cover 260 and limits a position of the guide cover 260. At this time, most of the magnetorheological fluid is located in the first chamber 2111, and the gas piston 220 is also at a maximum right displacement point while the gas chamber 212 is in a maximum compression state.

As shown in FIG. 19D, the force on the piston rod 110 decreases or disappears. Under the action of high-pressure nitrogen in the gas chamber 212, the gas piston 220 gradually moves to the left, the volume of the gas chamber 212 increases, and the volume of the magnetorheological fluid chamber 211 decreases, which causes the piston rod 110 to gradually move to the left and reset and to extend out of the cylinder tube 210. The piston rod 110 drives the piston 120 to gradually move to the left. During this process, the magnetorheological fluid in the first chamber 2111 enters the piston 120 from the first magnetorheological fluid inlet/outlet 1211, and sequentially flows through the first axial flow channel 1201, the first radial flow channel 1272, the central through-hole 1241, the second radial flow channel 1282, and the second axial flow channel 1202 and then flows out from the second magnetorheological fluid inlet/outlet 1212 and flows into the second chamber 2112, until the piston rod 110 and the piston 120 are fully restored to their initial state (as shown in FIG. 19E).

### Examples

In some embodiments in accordance with the present technology (example 1), a piston assembly for a magnetorheological damper includes a piston rod, wherein the piston rod has a first end and a second end; and a piston connected to the first end of the piston rod, wherein the piston comprises: a shell provided with a first magnetorheological fluid inlet/outlet and a second magnetorheological fluid inlet/outlet, a first-end iron core arranged inside the shell, wherein there is a first gap between an outer peripheral surface of the first-end iron core and an inner peripheral surface of the shell, and the first gap is in connection with the first magnetorheological fluid inlet/outlet to form a first axial flow channel, a second-end iron core arranged inside the shell, wherein there is a second gap between an outer peripheral surface of the second-end iron core and an inner peripheral surface of the shell, and the second gap is in connection with the second magnetorheological fluid inlet/outlet to form a second axial flow channel, a main iron core, wherein the main iron core has a central through-hole, the main iron core is arranged inside the shell and located between the first-end iron core and the second-end iron core, and the main iron core is spaced from the first-end iron core and is spaced from the second-end iron core, a coil bracket arranged inside the shell and sleeved on the main iron core, an electromagnetic coil wound around an outer peripheral surface of the coil bracket, a first supporting frame arranged inside the shell, wherein the first supporting frame comprises a plurality of first legs sandwiched between the first-end iron core and the main iron core and arranged radially to form, between the first-end iron core and the main iron core, a plurality of first radial flow channels connected with the central through-hole, and the first radial flow channel is in connection with the first gap, and a second supporting frame arranged inside the shell, wherein the second supporting frame comprises a plurality of second legs sandwiched between the second-end iron core and the main iron core and arranged radially to form, between the second-end iron core and the main iron core, a plurality of second radial flow channels connected with the central through-hole, and the second radial flow channel is in connection with the second gap.

Example 2 includes the piston assembly of example 1 or any of examples 1-14, wherein the shell comprises: a sleeve for iron cores; a first piston cover, wherein the first piston cover is arranged at a first end of the sleeve and connected to the piston rod, and the first magnetorheological fluid inlet/outlet is formed on the first piston cover and is aligned with the first gap in an axial direction of the sleeve; and a second piston cover, wherein the second piston cover is arranged at a second end of the sleeve and connected to the piston rod, and the second magnetorheological fluid inlet/outlet is formed on the second piston cover and is aligned with the second gap in the axial direction of the sleeve.

Example 3 includes the piston assembly of example 2 or any of examples 1-14, wherein, a plurality of the first magnetorheological fluid inlet/outlet are provided and spaced in a circumferential direction of the first piston cover; and/or a plurality of the second magnetorheological fluid inlet/outlet are provided and spaced in a circumferential direction of the second piston cover.

Example 4 includes the piston assembly of example 2 or any of examples 1-14, wherein the first magnetorheological fluid inlet/outlet is arc-shaped, extending along a circumferential direction of the first piston cover, and/or the second magnetorheological fluid inlet/outlet is arc-shaped, extending along a circumferential direction of the second piston cover.

Example 5 includes the piston assembly of example 1 or any of examples 1-14, wherein a first end of the shell is provided with a first connecting hole, and the first-end iron core is provided with a second connecting hole, wherein the first connecting hole, the second connecting hole, and the central through-hole of the main iron core are aligned centrally in an axial direction of the main iron core, the first end of the piston rod is connected inside the first connecting hole and the second connecting hole, and a lead wire through-hole extending along an axial direction of the piston rod is provided inside the piston rod; and the electromagnetic coil comprises a first lead wire and a second lead wire, and the first lead wire and the second lead wire extend from the central through-hole of the main iron core and extend outward through the lead wire through-hole.

Example 6 includes the piston assembly of example 5 or any of examples 1-14, wherein a filling layer for preventing the first lead wire and the second lead wire from moving is filled inside the lead wire through-hole.

Example 7 includes the piston assembly of example 1 or any of examples 1-14, wherein, an annular groove is provided on an outer peripheral surface of the coil bracket, and the electromagnetic coil is arranged inside the annular groove, the electromagnetic coil comprises a first lead wire and a second lead wire, the annular groove has a first side wall and a second side wall, the first side wall is provided with a first through slot, the first lead wire passes through the first through slot and extends outward, the second side wall is provided with a second through slot, and the second lead wire passes through the second through slot and extends outward.

Example 8 includes the piston assembly of example 7 or any of examples 1-14, wherein, the first through slot is aligned with one first leg in the plurality of first legs, the first leg is provided with a first lead wire channel extending along a length direction of the first leg, and the first lead wire extends inward along a radial direction of the main iron core through the first lead wire channel and then extends outward along an axial direction of the main iron core; and the second through slot is aligned with one second leg in the plurality of second legs, the second leg is provided with a second lead wire channel extending along a length direction of the second leg, and the second lead wire extends inward along a radial direction of the main iron core through the second lead wire channel and then extends outward by passing through the central through-hole of the main iron core.

Example 9 includes the piston assembly of example 8 or any of examples 1-14, wherein, the first supporting frame comprises a first supporting tube, the plurality of first legs extend outward from the first supporting tube along a radial direction of the first supporting tube, a part of the first supporting tube is matched in the central through-hole of the main iron core, and a first guide slot extending along an axial direction of the first supporting tube is provided on the first supporting tube; and the second supporting frame comprises a second supporting tube, the plurality of second legs extend outward from the second supporting tube along a radial direction of the second supporting tube, a part of the second supporting tube is matched in the central through-hole of the main iron core and contacts with the first supporting tube, a second guide slot extending along an axial direction of the second supporting tube is provided on the second supporting tube, and the first guide slot is aligned with the second guide slot to guide the second lead wire to pass through the central through-hole of the main iron core.

Example 10 includes the piston assembly of example 9 or any of examples 1-14, wherein the second guide slot is adjacent to and is in connection with the second lead wire channel.

Example 11 includes the piston assembly of example 1 or any of examples 1-14, wherein, the first supporting frame comprises a first supporting tube, a part of the first supporting tube is matched in the central through-hole of the main iron core, the plurality of first legs are spaced in a circumferential direction of the first supporting tube and connected to an outer peripheral surface of the first supporting tube, and the first supporting tube is provided with a first pass-through slot for connecting the first radial flow channel with the central through-hole; and/or the second supporting frame comprises a second supporting tube, a part of the second supporting tube is matched in the central through-hole of the main iron core, the plurality of second legs are spaced in a circumferential direction of the second supporting tube and connected to an outer peripheral surface of the second supporting tube, and the second supporting tube is provided with a second pass-through slot for connecting the second radial flow channel with the central through-hole.

Example 12 includes the piston assembly of example 1 or any of examples 1-14, wherein the coil bracket has a first end face and a second end face opposite to the first end face in an axial direction of the coil bracket; the first leg is in contact with the first end face, and an outer end face of the first leg is flush with an outer circumferential edge of the first end face; and/or the second leg is in contact with the second end face, and an outer end face of the second leg is flush with an outer circumferential edge of the second end face.

Example 13 includes the piston assembly of example 12 or any of examples 1-14, wherein, a plurality of first clamp slots are provided on the first end face, and the plurality of first legs are clamped in the plurality of first clamp slots, respectively; and/or a plurality of second clamp slots are provided on the second end face, and the plurality of second legs are clamped in the plurality of second clamp slots, respectively.

Example 14 includes the piston assembly of example 1 or any of examples 1-13, wherein an annular clamp slot is provided on an outer peripheral surface of the shell, a wear-reducing member is provided inside the annular clamp slot, and an outer peripheral surface of the wear-reducing member is higher than the outer peripheral surface of the shell.

In some embodiments in accordance with the present technology (example 15), a magnetorheological damper includes a cylinder tube with a first end and a second end; and the piston assembly of any of examples 1-14, wherein the piston of the piston assembly is arranged in an inner chamber of the cylinder tube and is moveable along an axial direction of the cylinder tube, and the second end of the piston rod extends from the second end of the cylinder tube.

Example 16 includes the magnetorheological damper of example 15 or any of examples 15-18, further comprising a gas piston, wherein the gas piston is arranged in the inner chamber of the cylinder tube and is moveable along the axial direction of the cylinder tube to divide the inner chamber of the cylinder tube into a magnetorheological fluid chamber located on a first side of the gas piston and a gas chamber located on a second side of the gas piston, wherein the cylinder tube is provided with a valve core opening connected with the gas chamber, wherein a valve core assembly is provided at the valve core opening, and wherein the piston of the piston assembly is movably arranged in the magnetorheological fluid chamber.

Example 17 includes the magnetorheological damper of example 15 or any of examples 15-18, further comprising: a first connector and a second connector, wherein the first connector is connected to the second end of the piston rod, and the second connector is connected to the first end of the cylinder tube.

Example 18 includes the magnetorheological damper of example 17 or any of examples 15-16, further comprising: a buffer block, wherein the buffer block is located between the first connector and the second end of the cylinder tube and is provided on one of the first connector, the piston rod, and the second end of the cylinder tube.

In some embodiments in accordance with the present technology (example 19), a vehicle includes a vehicle frame; a suspension frame; and the magnetorheological damper of any of examples 15-18, wherein the magnetorheological damper is arranged between the vehicle frame and the suspension frame.

In some embodiments in accordance with the present technology (example 20), a vehicle includes a vehicle frame; a suspension frame; and a magnetorheological damper, comprising: a cylinder tube with a first end and a second end; and a piston assembly, wherein the piston assembly comprises: a piston rod, wherein the piston rod has a first end and a second end; and a piston connected to the first end of the piston rod, wherein the piston comprises: a shell provided with a first magnetorheological fluid inlet/outlet and a second magnetorheological fluid inlet/outlet, a first-end iron core arranged inside the shell, wherein there is a first gap between an outer peripheral surface of the first-end iron core and an inner peripheral surface of the shell, and the first gap is in connection with the first magnetorheological fluid inlet/outlet to form a first axial flow channel, a second-end iron core arranged inside the shell, wherein there is a second gap between an outer peripheral surface of the second-end iron core and an inner peripheral surface of the shell, and the second gap is in connection with the second magnetorheological fluid inlet/outlet to form a second axial flow channel, a main iron core, wherein the main iron core has a central through-hole, the main iron core is arranged inside the shell and located between the first-end iron core and the second-end iron core, the main iron core is spaced from the first-end iron core and is spaced from the second-end iron core, a coil bracket arranged inside the shell and sleeved on the main iron core, an electromagnetic coil wound around an outer peripheral surface of the coil bracket, a first supporting frame arranged inside the shell, wherein the first supporting frame comprises a plurality of first legs sandwiched between the first-end iron core and the main iron core and arranged radially to form, between the first-end iron core and the main iron core, a plurality of first radial flow channels connected with the central through-hole, and the first radial flow channel is in connection with the first gap, and a second supporting frame arranged inside the shell, wherein the second supporting frame comprises a plurality of second legs sandwiched between the second-end iron core and the main iron core and arranged radially to form, between the second-end iron core and the main iron core, a plurality of second radial flow channels connected with the central through-hole, and the second radial flow channel is in connection with the second gap; wherein the piston of the piston assembly is arranged in an inner chamber of the cylinder tube and is moveable along an axial direction of the cylinder tube, and the second end of the piston rod extends from the second end of the cylinder tube; wherein the magnetorheological damper is arranged between the vehicle frame and the suspension frame; and wherein the magnetorheological damper further comprises a first connector and a second connector, the first connector is connected to the second end of the piston rod, and the second connector is connected to the first end of the cylinder tube.

### CONCLUSION

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. For example, components of the vehicle that employs an example embodiment of the magnetorheological damper or piston assembly in accordance with the present technology can include a control unit embodying various systems, digital electronic circuitry, or in computer software, firmware, or hardware.

Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., FPGA (field programmable gate array) or ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

In the description of the present technology, it should be understood that orientations or position relationships indicated by the terms “central,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” “circumferential,” etc., are based on the orientations or position relationships illustrated in the accompanying drawings and are only for convenience of describing the present technology and simplifying the description rather than indicating or implying that devices or components referred to must have a particular orientation or be constructed and operated in the particular orientation. Therefore, it cannot be understood as a limitation on the present technology.

In addition, the terms “first” and “second” are only used to describe the purpose and cannot be understood as indicating or implying relative importance or implying the quantity of technical features indicated. Therefore, features limited to “first” and “second” may explicitly or implicitly include at least one of these features. In the description disclosed herein, “a plurality of” means at least two, such as two, three, etc., unless otherwise specified with specific limitations.

In the present disclosure, unless otherwise specified and limited, the terms “mount,” “couple,” “connect,” “fix,” and other terms should be broadly understood. For example, they may be a fixed connection, a detachable connection, or integrated. They may also be a mechanical connection, an electrical connection, or a communication with each other. They may be directly coupled or indirectly coupled through an intermediate medium. They may be an internal connection of two components or an interaction relationship between two components, unless otherwise specified. For those of ordinary skill in the art, specific meanings of the above terms in the present disclosure may be understood based on specific cases.

In the present disclosure, unless otherwise specified and limited, the first feature is “above” or “below” the second feature, which means that the first feature may be in direct contact with the second feature, or the first feature may be in indirect contact with the second feature through an intermediate media. Moreover, if the first feature is “on,” “above,” and “on top of” the second feature, that means the first feature is directly or diagonally above the second feature, or simply indicates that the first feature is horizontally higher than the second feature. If the first feature is “under,” “below,” and “on bottom of” the second feature, that means the first feature is directly or diagonally below the second feature, or simply indicates that the horizontal height of the first feature is less than that of the second feature.

In the present disclosure, the terms “an embodiment,” “some embodiments,” “an example,” “a specific example,” or “some examples” mean that a specific feature, structure, material, or characteristic described in connection with embodiments or examples is included in at least one embodiment or example of the present technology. In this specification, the illustrative expressions of the above terms do not necessarily refer to the same embodiments or examples. Moreover, the specific feature, structure, material, or characteristic described may be combined in any suitable manner in one or more embodiments or examples. In addition, those skilled in the art may connect and combine different embodiments or examples as well as features of different embodiments or examples described in this specification without conflicting with each other.

Although embodiments of the present technology have been illustrated and described above, it may be understood that the above embodiments are illustrative and cannot be understood as a limitation of the present technology. Those of ordinary skill in the art may make changes, modifications, alternatives, and variations to the above embodiments within the scope of the present technology.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A piston assembly for a magnetorheological damper, the piston assembly comprising:
a piston rod, wherein the piston rod has a first end and a second end; and
a piston connected to the first end of the piston rod,
wherein the piston comprises:
a shell provided with a first magnetorheological fluid inlet/outlet and a second magnetorheological fluid inlet/outlet,
a first-end iron core arranged inside the shell, wherein there is a first gap between an outer peripheral surface of the first-end iron core and an inner peripheral surface of the shell, and the first gap is in connection with the first magnetorheological fluid inlet/outlet to form a first axial flow channel,
a second-end iron core arranged inside the shell, wherein there is a second gap between an outer peripheral surface of the second-end iron core and an inner peripheral surface of the shell, and the second gap is in connection with the second magnetorheological fluid inlet/outlet to form a second axial flow channel,
a main iron core, wherein the main iron core has a central through-hole, the main iron core is arranged inside the shell and located between the first-end iron core and the second-end iron core, and the main iron core is spaced from the first-end iron core and is spaced from the second-end iron core,
a coil bracket arranged inside the shell and sleeved on the main iron core,
an electromagnetic coil wound around an outer peripheral surface of the coil bracket,
a first supporting frame arranged inside the shell, wherein the first supporting frame comprises a plurality of first legs sandwiched between the first-end iron core and the main iron core and arranged radially to form, between the first-end iron core and the main iron core, a plurality of first radial flow channels connected with the central through-hole, and the first radial flow channel is in connection with the first gap, and
a second supporting frame arranged inside the shell, wherein the second supporting frame comprises a plurality of second legs sandwiched between the second-end iron core and the main iron core and arranged radially to form, between the second-end iron core and the main iron core, a plurality of second radial flow channels connected with the central through-hole, and the second radial flow channel is in connection with the second gap.

2. The piston assembly of claim 1, wherein the shell comprises:
a sleeve for iron cores;
a first piston cover, wherein the first piston cover is arranged at a first end of the sleeve and connected to the piston rod, and the first magnetorheological fluid inlet/outlet is formed on the first piston cover and is aligned with the first gap in an axial direction of the sleeve; and
a second piston cover, wherein the second piston cover is arranged at a second end of the sleeve and connected to the piston rod, and the second magnetorheological fluid inlet/outlet is formed on the second piston cover and is aligned with the second gap in the axial direction of the sleeve.

3. The piston assembly of claim 2, wherein,
a plurality of the first magnetorheological fluid inlet/outlet are provided and spaced in a circumferential direction of the first piston cover; and/or
a plurality of the second magnetorheological fluid inlet/outlet are provided and spaced in a circumferential direction of the second piston cover.

4. The piston assembly of claim 2, wherein the first magnetorheological fluid inlet/outlet is arc-shaped, extending along a circumferential direction of the first piston cover, and/or the second magnetorheological fluid inlet/outlet is arc-shaped, extending along a circumferential direction of the second piston cover.

5. The piston assembly of claim 1,
wherein a first end of the shell is provided with a first connecting hole, and the first-end iron core is provided with a second connecting hole, wherein the first connecting hole, the second connecting hole, and the central through-hole of the main iron core are aligned centrally in an axial direction of the main iron core, the first end of the piston rod is connected inside the first connecting hole and the second connecting hole, and a lead wire through-hole extending along an axial direction of the piston rod is provided inside the piston rod; and
the electromagnetic coil comprises a first lead wire and a second lead wire, and the first lead wire and the second lead wire extend from the central through-hole of the main iron core and extend outward through the lead wire through-hole.

6. The piston assembly of claim 5, wherein a filling layer for preventing the first lead wire and the second lead wire from moving is filled inside the lead wire through-hole.

7. The piston assembly of claim 1, wherein,
an annular groove is provided on an outer peripheral surface of the coil bracket, and the electromagnetic coil is arranged inside the annular groove, the electromagnetic coil comprises a first lead wire and a second lead wire, the annular groove has a first side wall and a second side wall, the first side wall is provided with a first through slot, the first lead wire passes through the first through slot and extends outward, the second side wall is provided with a second through slot, and the second lead wire passes through the second through slot and extends outward.

8. The piston assembly of claim 7, wherein,
the first through slot is aligned with one first leg in the plurality of first legs, the first leg is provided with a first lead wire channel extending along a length direction of the first leg, and the first lead wire extends inward along a radial direction of the main iron core through the first lead wire channel and then extends outward along an axial direction of the main iron core; and
the second through slot is aligned with one second leg in the plurality of second legs, the second leg is provided with a second lead wire channel extending along a length direction of the second leg, and the second lead wire extends inward along a radial direction of the main iron core through the second lead wire channel and then extends outward by passing through the central through-hole of the main iron core.

9. The piston assembly of claim 8, wherein,
the first supporting frame comprises a first supporting tube, the plurality of first legs extend outward from the first supporting tube along a radial direction of the first supporting tube, a part of the first supporting tube is matched in the central through-hole of the main iron core, and a first guide slot extending along an axial direction of the first supporting tube is provided on the first supporting tube; and
the second supporting frame comprises a second supporting tube, the plurality of second legs extend outward from the second supporting tube along a radial direction of the second supporting tube, a part of the second supporting tube is matched in the central through-hole of the main iron core and contacts with the first supporting tube, a second guide slot extending along an axial direction of the second supporting tube is provided on the second supporting tube, and the first guide slot is aligned with the second guide slot to guide the second lead wire to pass through the central through-hole of the main iron core.

10. The piston assembly of claim 9, wherein the second guide slot is adjacent to and is in connection with the second lead wire channel.

11. The piston assembly of claim 1, wherein,
the first supporting frame comprises a first supporting tube, a part of the first supporting tube is matched in the central through-hole of the main iron core, the plurality of first legs are spaced in a circumferential direction of the first supporting tube and connected to an outer peripheral surface of the first supporting tube, and the first supporting tube is provided with a first pass-through slot for connecting the first radial flow channel with the central through-hole; and/or
the second supporting frame comprises a second supporting tube, a part of the second supporting tube is matched in the central through-hole of the main iron core, the plurality of second legs are spaced in a circumferential direction of the second supporting tube and connected to an outer peripheral surface of the second supporting tube, and the second supporting tube is provided with a second pass-through slot for connecting the second radial flow channel with the central through-hole.

12. The piston assembly of claim 1, wherein the coil bracket has a first end face and a second end face opposite to the first end face in an axial direction of the coil bracket;
the first leg is in contact with the first end face, and an outer end face of the first leg is flush with an outer circumferential edge of the first end face; and/or
the second leg is in contact with the second end face, and an outer end face of the second leg is flush with an outer circumferential edge of the second end face.

13. The piston assembly of claim 12, wherein,
a plurality of first clamp slots are provided on the first end face, and the plurality of first legs are clamped in the plurality of first clamp slots, respectively; and/or
a plurality of second clamp slots are provided on the second end face, and the plurality of second legs are clamped in the plurality of second clamp slots, respectively.

14. The piston assembly of claim 1, wherein an annular clamp slot is provided on an outer peripheral surface of the shell, a wear-reducing member is provided inside the annular clamp slot, and an outer peripheral surface of the wear-reducing member is higher than the outer peripheral surface of the shell.

15. A magnetorheological damper, comprising:
a cylinder tube with a first end and a second end; and
the piston assembly of claim 1, wherein the piston of the piston assembly is arranged in an inner chamber of the cylinder tube and is moveable along an axial direction of the cylinder tube, and the second end of the piston rod extends from the second end of the cylinder tube.

16. The magnetorheological damper of claim 15, further comprising
a gas piston,
wherein the gas piston is arranged in the inner chamber of the cylinder tube and is moveable along the axial direction of the cylinder tube to divide the inner chamber of the cylinder tube into a magnetorheological fluid chamber located on a first side of the gas piston and a gas chamber located on a second side of the gas piston,
wherein the cylinder tube is provided with a valve core opening connected with the gas chamber,
wherein a valve core assembly is provided at the valve core opening, and
wherein the piston of the piston assembly is movably arranged in the magnetorheological fluid chamber.

17. The magnetorheological damper of claim 15, further comprising:
a first connector and a second connector,
wherein the first connector is connected to the second end of the piston rod, and the second connector is connected to the first end of the cylinder tube.

18. The magnetorheological damper of claim 17, further comprising:
a buffer block,
wherein the buffer block is located between the first connector and the second end of the cylinder tube and is provided on one of the first connector, the piston rod, and the second end of the cylinder tube.

19. A vehicle, comprising:
a vehicle frame;
a suspension frame; and
the magnetorheological damper of claim 15, wherein the magnetorheological damper is arranged between the vehicle frame and the suspension frame.

20. A vehicle, comprising:
a vehicle frame;
a suspension frame; and
a magnetorheological damper, comprising:
a cylinder tube with a first end and a second end; and
a piston assembly,
wherein the piston assembly comprises:
a piston rod, wherein the piston rod has a first end and a second end; and
a piston connected to the first end of the piston rod,
wherein the piston comprises:
a shell provided with a first magnetorheological fluid inlet/outlet and a second magnetorheological fluid inlet/outlet,
a first-end iron core arranged inside the shell, wherein there is a first gap between an outer peripheral surface of the first-end iron core and an inner peripheral surface of the shell, and the first gap is in connection with the first magnetorheological fluid inlet/outlet to form a first axial flow channel,
a second-end iron core arranged inside the shell, wherein there is a second gap between an outer peripheral surface of the second-end iron core and an inner peripheral surface of the shell, and the second gap is in connection with the second magnetorheological fluid inlet/outlet to form a second axial flow channel,
a main iron core, wherein the main iron core has a central through-hole, the main iron core is arranged inside the shell and located between the first-end iron core and the second-end iron core, the main iron core is spaced from the first-end iron core and is spaced from the second-end iron core,
a coil bracket arranged inside the shell and sleeved on the main iron core,
an electromagnetic coil wound around an outer peripheral surface of the coil bracket,
a first supporting frame arranged inside the shell, wherein the first supporting frame comprises a plurality of first legs sandwiched between the first-end iron core and the main iron core and arranged radially to form, between the first-end iron core and the main iron core, a plurality of first radial flow channels connected with the central through-hole, and the first radial flow channel is in connection with the first gap, and
a second supporting frame arranged inside the shell, wherein the second supporting frame comprises a plurality of second legs sandwiched between the second-end iron core and the main iron core and arranged radially to form, between the second-end iron core and the main iron core, a plurality of second radial flow channels connected with the central through-hole, and the second radial flow channel is in connection with the second gap;
wherein the piston of the piston assembly is arranged in an inner chamber of the cylinder tube and is moveable along an axial direction of the cylinder tube, and the second end of the piston rod extends from the second end of the cylinder tube;
wherein the magnetorheological damper is arranged between the vehicle frame and the suspension frame; and
wherein the magnetorheological damper further comprises a first connector and a second connector, the first connector is connected to the second end of the piston rod, and the second connector is connected to the first end of the cylinder tube.
